(19) United States
(12) Patent Application Publication
(10) Pub. No.: US 2024/0304885 A1
(43) Pub. Date: Sep. 12, 2024

(54) A RECYCLING METHOD FOR RECOVERY OF LITHIUM FROM MATERIALS COMPRISING LITHIUM AND ONE OR MORE TRANSITION METALS

(71) Applicant: Gelion Technologies Pty Ltd, Eveleigh (AU)

(72) Inventors: Koen Vandaele, Sonning Common (GB); Harry Iain Robert Macpherson, Sonning Common (GB); Celia Achaibou, Sonning Common (GB)

(21) Appl. No.: 18/694,286

(22) PCT Filed: Jul. 21, 2022
(86) PCT No.: PCT/GB2022/051885

§ 371 Date: Mar. 21, 2024

(30) Foreign Application Priority Data
Sep. 21, 2021 (GB) 2113426.7

(51) Int. Cl. H01M 10/54; C22B 7/00; C25B 1/16; C25B 9/19

(52) U.S. Cl. CPC H01M 10/54; C22B 7/007; C25B 1/16; C25B 9/19

(57) ABSTRACT

A method for recycling lithium from an input material comprising lithium and one or more transition metals, comprising the steps of: contacting said input material with a leaching medium comprising an organic acid; leaching lithium from the input material to form a leachate comprising an organic lithium salt; and electrolytically converting the organic lithium salt into an inorganic lithium salt in an electrochemical cell.

### TECHNICAL FIELD

The present specification relates to a recycling method for recovery of lithium from materials comprising lithium and one or more transition metals. The method is particularly suited to the recovery of lithium from waste battery materials including so-called “black-mass”.

### BACKGROUND ART

The number of portable electronic devices requiring rechargeable batteries (e.g. smartphones and laptops) is increasing year on year. With growing concerns for the environment, the automotive sector is looking for alternatives to the internal combustion engine and rechargeable batteries provide one solution. With increasing consumer take-up of hybrid and fully electric vehicles powered by rechargeable batteries, the world's demand for rechargeable batteries is only expected to grow.

Modern rechargeable batteries typically include a cathode material based on a transition metal oxide framework containing intercalated lithium. Examples include LiCoO₂, LiMn₂O₄, LiFePO₄, LiNiCoAlO₂ and LiNiₓMn_{y}Co_{z}O₂ (“NMC”). One material showing promise for automotive applications is “NMC” (lithium-nickel-manganese-cobalt), which is represented by the general formula LiNiₓMn_{y}Co_{z}O₂ where x+y+z=1. There is a desire to provide routes to recover and recycle the metals used in the cathode materials of batteries. This is particularly important for Co, Ni and Li, and to a lesser extent Mn.

The recovery of Li, Ni, Mn and Co from NMC materials has been studied previously. In a typical process the metals are solubilized from cathode scrap (e.g. so-called “black-mass”) using an acidic leaching medium (e.g. sulfuric acid) to form a leachate containing metal ions and are then separated by a series of precipitations using pH adjustment and/or solvent extractions. Fe, Al and Cu may be removed from the leachate by various methods including sulfiding or precipitation using NaOH. Mn, Co and Ni are typically separated from the leachate by precipitation and/or solvent extraction, but are often contaminated with Li impurities. Li is usually the last material left in solution and is precipitated e.g. as Li₂CO₃. However, at this stage the leachate includes sodium ions which were introduced previously when precipitating Fe, Al and Cu, and during the solvent extraction. The precipitation of Li often uses Na₂CO₃ as a source of carbonate and is prone to producing Li₂CO₃ contaminated with Na₂CO₃, from which it is difficult to obtain high purity Li. It would therefore be advantageous if Li could be removed from the cathode scrap prior to leaching and separation of the transition metal components such as Ni, Co, and Mn.

To provide a more straightforward recycling route, particularly for Li-ion battery scrap, it would be advantageous to provide a method which can selectively remove Li from the solid starting material prior to extracting and separating one or more transition metal components from the solid starting material. The present specification addresses this problem.

### SUMMARY OF THE INVENTION

Describe herein is a method for recycling lithium from an input material comprising lithium and one or more transition metals, comprising the steps of:
contacting said input material with a leaching medium comprising an organic acid;
leaching lithium from the input material to form a leachate comprising an organic lithium salt; and
electrolytically converting the organic lithium salt into an inorganic lithium salt in an electrochemical cell.

Preferably the organic acid in the leaching medium is formic acid. In this case, the organic lithium salt in the leachate is in the form of lithium formate, and the lithium formate is converted to an inorganic lithium salt in the electrochemical cell. The inorganic lithium salt may be lithium hydroxide or lithium carbonate.

The steps of contacting the input material and leaching lithium from the input material to form a leachate comprising an organic lithium salt such as lithium formate are described in the proprietor's earlier GB patent application number 2016329.1 filed on 15 Oct. 2020. For example, it has been established that it is possible to selectively leach Li from the input material if the concentration of formic acid in the leaching medium is sufficiently high. Without wishing to be bound by any theory, it is thought that the high selectivity for leaching of Li is a result of the poor solubility of transition metals at high concentrations of formic acid. In contrast, Li ions are highly soluble in formic acid and form soluble lithium formate in situ. Previous reports of separating these metals from NMC cathode scrap only investigated the use of dilute formic acid under which conditions Ni(II), Co(II), and Mn(II) have appreciable solubility in the leaching medium.

The selective formic acid leach of lithium, e.g. from black-mass, produces a highly concentrated aqueous solution of formic acid mainly containing lithium, accompanied by other metals in lower concentrations. For the lithium extraction approach to be economically and environmentally viable as a recycling method, it is desirable for the lithium formate in this solution to be converted to high purity lithium hydroxide or lithium carbonate for re-use in lithium ion battery cathode material synthesis and the formic acid recycled for reuse in the leaching step of the recycling process. The present specification builds on the work described in GB patent application number 2016329.1 by providing a further process for electrolytically converting the organic lithium salt (e.g., lithium formate) in the leachate to an inorganic lithium salt such as lithium hydroxide in order to enable this requirement. A number of different electrochemical processing methodologies and cell configurations are described in this specification for achieving this functionality. According to certain embodiments, the electrochemical processing methodologies and cell configurations use one or more membranes which are selective, e.g. either under certain pH conditions or by special design of the membrane, to the transmission of monovalent lithium over multivalent transition metals. In this case, such electrochemical cell configurations and methods are capable of both separating the lithium from multivalent transition metal impurities in the leachate and converting the lithium formate to an inorganic lithium salt such as lithium hydroxide. Alternatively, or additionally, a multivalent metal separation step (such as an ion exchange process) may be applied to the leachate prior to electrolysis. In this case, the use of a selective membrane is not necessarily required in the electrochemical cell configuration which is then only required to convert the lithium formate to lithium hydroxide.

While the electrochemical processing technologies are described in the context of using formic acid, and particularly concentrated formic acid, as the organic acid for leaching lithium from the input material, the same electrochemical processing technologies can be applied when using different organic acids for the leaching step. Examples of organic acids for the leaching process include formic acid, acetic acid, propionic acid, malonic acid, citric acid, butyric acid, oxalic acid, tartaric acid, or a mixture of two or more of these organic acids. Furthermore, while the inorganic lithium salt is preferably lithium hydroxide, it is also possible to produce other inorganic lithium salts. For example, lithium carbonate can be formed electrochemically.

Advantageously, the electrochemical methodologies and cell configurations described herein are tailored to reduce formate oxidation within the electrochemical cell (or oxidation of other organic acid derivatives where other organic acids are used in the leaching medium). This enables a significant portion of the organic acid (e.g. formic acid) to be regenerated and recycled from the electrochemical cell for re-use in the leaching process. For example, at least 50%, 60%, 70%, 80%, or 90% by weight of the organic acid in the leaching medium can be recycled from the electrochemical cell.

In certain configurations, the lithium hydroxide produced in the electrochemical cell comprises a mixture of hydroxide and formate (or other organic acid derivative). In this case, advantageously the method further comprises selectively precipitating lithium hydroxide (or other inorganic lithium salt) from the mixture at a temperature of at least 60° C., 70° C., 80° C., 90° C., or 100° C. Supernatant from the precipitation can be recycled to the electrochemical cell so as to recycle the formate (or other organic acid derivative) and also extract any further lithium remaining in the supernatant. The precipitated lithium hydroxide can be washed and the resultant wash liquor also recycled through the electrochemical cell, again ensuring that lithium extraction is increased and minimizing formate loss from the system. The lithium hydroxide can then be dried ready for use in manufacturing new lithium containing functional materials such as lithium ion battery cathode materials. Water evaporated during processing (e.g. in the drying step and/or during precipitation) can also be recycled back into the system, e.g. for re-use in the washing step.

The electrochemical cell can be designed to selectively extract lithium from the leachate over transition metal impurities within the leachate. For example, the electrochemical cell may comprise a diluate chamber for receiving the leachate and a concentrate chamber separated from the diluate chamber by a cation exchange membrane which selectively allows lithium ions to pass from the diluate chamber to the concentrate chamber forming lithium hydroxide in the concentrate chamber while blocking multivalent transition metals. A pH gradient is maintained across the cation exchange membrane in operation which ensures that the cation exchange membrane is monovalent selective with a significant reduction in the flux of multivalent ions across the membrane. The pH gradient also decreases the flux of uncharged molecules such as molecular formic acid across the membrane. Multivalent transition metals build up on the cation exchange membrane during operation and can be periodically removed from the cation exchange membrane by chemically stripping or by periodically reversing the cell current. Alternatively, if a specialised monovalent selective cation exchange membrane is used (i.e., a permiselective cation exchange membrane for monovalent ions) then monovalent selectivity can be based on 2+ charge repulsion rather than a pH gradient.

One method for reducing formate oxidation (or oxidation of other organic acid derivatives) within the electrochemical cell as described above is to provide a configuration which further comprises one or more bipolar membranes. For example, a bipolar membrane can be provided adjacent each of the diluate and concentrate chambers separating the chambers from the anode/anolyte and cathode/catholyte. That is, the electrochemical cell may comprise an anolyte chamber in contact with an anode, the anolyte chamber being separated from the diluate chamber adjacent the anolyte chamber by a bipolar membrane, and wherein the electrochemical cell further comprises a catholyte chamber in contact with a cathode, the catholyte chamber being separated from the concentrate chamber adjacent the catholyte chamber by a bipolar membrane. Alternatively, to limit oxidation, a single bipolar membrane can be provided adjacent to the diluate chamber. Alternatively, or additionally, a suitable anode material can be selected which is not able to perform the organic acid (e.g., formic acid) oxidation and thus minimise organic acid loss.

Advantageously, a plurality of pairs of diluate and concentrate chambers are provided, each pair being separated by a bipolar membrane. Such a configuration thus comprises a series of repeat units separated by a bipolar membrane, each repeat unit comprising a diluate chamber receiving the leachate and a concentration chamber in which lithium hydroxide is formed. The electrochemical cell comprises at least 3, 4, 6, 8, 10, 15, 20, 50, 100, 200, 300, or 350 pairs of diluate and concentrate chambers (e.g., up to 400 or 500).

The use of bipolar membranes allows the majority of protons formed in the electrolysis to be generated by water dissociation rather than water oxidation and may aid in significantly reducing the rate of formic acid oxidation.

Alternatively, it is possible to design cell configurations which reduce formate oxidation (or reduce oxidation of other organic acid derivatives) without requiring bipolar membranes. For example, a three-chamber electrochemical cell configuration may be provided with the chambers separated by cation exchange membranes. Such a configuration comprises a central diluate chamber for receiving the leachate and a concentrate chamber or catholyte (adjacent the cathode) separated from the diluate chamber by a cation exchange membrane which selectively allows lithium ions to pass from the diluate chamber to the concentrate chamber forming lithium hydroxide in the concentrate chamber while blocking multivalent transition metals. The cell configuration further comprises an anolyte chamber in contact with an anode, the anolyte chamber being separated from the diluate chamber adjacent the anolyte chamber by a cation exchange membrane. The electrolyte in the anolyte chamber (e.g. lithium sulfate/sulfuric acid solution) and the cation exchange membrane between the lithium formate solution in the central diluate chamber and the anode aids in blocking diffusion of formate ions and formic acid and so reduces oxidation of formate at the anode.

In the three-chamber configuration described above, there is still some crossover of organic acid (e.g. formic acid) to the anolyte and catholyte. This could be reduced by selecting membranes which are more resistant to organic acid (e.g. formic acid) cross-over. Alternatively, if the organic acid is deprotonated (i.e., the pH is adjusted/maintained above the pKa of the organic acid) then it won't be able to cross the cation exchange membrane. Organic acid crossover from the diluate into the catholyte of an electrochemical cell can be further reduced by forcing the organic acid to travel through a high pH solution, causing it to dissociate and therefore no longer be able to penetrate the cation exchange membrane in contact with the catholyte. As such, the electrochemical cell may further comprise a neutralization chamber disposed between the diluate chamber and the concentrate chamber, wherein the neutralization chamber is maintained at a pH above 4, 5, or 6 and/or wherein the neutralization chamber is maintained at a pH above a pKa of the organic acid.

The methodologies as describe herein can be applied to materials comprising one or more of nickel, manganese, and cobalt, in addition to Li, e.g. lithium ion battery scrap materials such as black-mass.

### BRIEF DESCRIPTION OF THE DRAWINGS

FIG. 1 shows an example of a battery materials recycling process;

FIG. 2 shows another example of a battery materials recycling process;

FIGS. 3(a) and 3(b) show process flow diagrams of a lithium extraction process which produces de-lithiated black-mass and lithium hydroxide, FIG. 3(b) showing that the lithium hydroxide can be re-introduced into a new cathode synthesis process in order to recycle the lithium from spent cathodes to produce new cathodes for lithium batteries;

FIG. 4 shows leaching results using 98% formic acid as leaching medium on NMC-111 as input material—the left-hand image shows the selectivity of the leaching medium and the right-hand image shows the efficiency of the leaching medium;

FIG. 5 shows leaching results using 98% formic acid as leaching medium with (NH₄)₂SO₄ as an additive on NMC-111 as input material—the left-hand image shows the selectivity of the leaching medium and the right-hand image shows the efficiency of the leaching medium;

FIG. 6 shows leaching results using an azeotrope of 77.5 wt % formic acid/22.5 wt % water as leaching medium on NMC-111 as input material—the left hand image shows the selectivity of the leaching medium and the right hand image shows the efficiency of the leaching medium;

FIG. 7 shows leaching results using an azeotrope of 77.5 wt % formic acid/22.5 wt % water as leaching medium with (NH₄)₂SO₄ as an additive on NMC-111 as input material—the left-hand image shows the selectivity of the leaching medium and the right-hand image shows the efficiency of the leaching medium;

FIG. 8 shows leaching results using a solution of 50 wt % formic acid/45 wt % water/5 wt % H₂O₂ as leaching medium on eLNO as input material—the left-hand image shows the selectivity of the leaching medium and the right-hand image shows the efficiency of the leaching medium;

FIG. 9 shows an electrochemical cell configuration for the electrolysis of lithium formate leachate to produce lithium hydroxide, the electrochemical cell configuration comprising a two-chamber repeating unit between an anode/anolyte and a cathode/catholyte (the repeating unit indicated by “ . . . ” in the figure), the system being configured to limit formate oxidation and enable high levels of formic acid recovery and recirculation whilst also selectively separating lithium hydroxide product from transition metals in the leachate;

FIG. 10 shows an example of the electrochemical cell configuration shown in FIG. 9;

FIG. 11 shows an expanded version of the electrochemical cell configuration shown in FIG. 10 comprising three of the two-chamber repeat units between the anode/anolyte and the cathode/catholyte;

FIG. 12 shows results for a cell configuration of FIG. 9, indicating a decrease in lithium concentration in the diluate and an increase in the lithium concentration in the concentrate overtime, with a cell configuration in which 25% formic acid was used as anolyte and catholyte and bipolar membranes were provided either side of a cation exchange membrane forming diluate and concentrate chambers, where the formic acid concentration in the diluate was 40%;

FIG. 13 shows results of the same cell set-up of FIG. 12, indicating selected elements in the four-chamber experiment and showing that the central cation exchange membrane (e.g. Nafion 424) is monovalent selective under these conditions—it is also evident that the bipolar membranes prevent the metals entering the anolyte and catholyte (although a small amount of sodium does cross over);

FIG. 14 shows a cation exchange membrane which has become loaded with multivalent metals (left hand side) and the same membrane after being stripping with 8 M H₂SO₄ (right hand side) illustrating that the system can be used to selectively extract Li over multivalent transition metals and that the membranes can be regenerated by chemical stripping (or alternatively via a periodic cell current reversal);

FIG. 15 shows the solubility of lithium formate and lithium hydroxide versus temperature indicating that lithium hydroxide can be selectively precipitated at elevated temperature from a lithium hydroxide/formate mixture produced via electrolysis of a lithium formate leachate;

FIG. 16 shows an example of a full process flow diagram for the electrolysis of lithium formate to produce lithium hydroxide including recirculation of formic acid through the leaching and electrolysis processes, selective precipitation and washing of lithium hydroxide product obtained from the electrolysis process, and recirculation of supernatant and wash liquor from the precipitation/washing process into the electrolysis process thereby providing an economically and ecologically viable system through efficient use of reagents;

FIG. 17 shows an example of a three-chamber electrolysis system that allows lithium formate containing solutions to be electrolysed to give formic acid and lithium hydroxide, the three-chamber system being configured to limit formate oxidation and enable high levels of formic acid recovery and recirculation whilst also selectively separating lithium hydroxide product from transition metals in the leachate;

FIG. 18 shows the change in concentration of lithium in the catholyte and anolyte overtime using the three-chamber electrolysis system;

FIG. 19 shows the change in concentration of lithium in the anolyte, diluate and catholyte (which in this case is the “concentrate”) with time using the three-chamber electrolysis system;

FIG. 20 shows concentrations of other selected elements in the anolyte, diluate and catholyte with time using the three-chamber electrolysis system;

FIG. 21 shows catholyte and anolyte pH versus time using the three-chamber electrolysis system;

FIG. 22 shows the concentration of formate in the anolyte and catholyte versus time using the three-chamber electrolysis system (as may be determined by analysing the carbon concentration, e.g., by ICP);

FIG. 23 shows a comparison of the changes in catholyte lithium concentration in the three-chamber electrolysis system when starting with a lower lithium concentration in the diluate (AI3822) and a higher lithium concentration in the diluate (AI3816)—results showing that lithium concentrates much more rapidly in the catholyte for the example in which the starting lithium concentration in the diluate is higher, providing a favourable concentration gradient and equating to higher current efficiency;

FIG. 24 shows a comparison of the cell voltages of experiments AI3816 and AI3822 using the three-chamber electrolysis system—results indicate that taking cell voltage and current efficiency into account, the specific energy consumption to produce lithium hydroxide from lithium formate is 8.1 kWh kg⁻¹ for AI3816 and 16.1 kWh kg⁻¹ for AI3822;

FIG. 25 shows an example of a three-chamber electrolysis system similar to that shown in FIG. 17;

FIG. 26 shows an example of a modified version of the configuration of FIG. 25 providing a four-chamber electrolysis system in which the formic acid feed chamber is separated from the LiOH product chamber by a “neutralisation chamber” intended to further reduce formate cross-over and formate oxidation;

FIGS. 27 and 28 show formic acid and water cross-over results for two different types of membrane, Nafion 115 and Nafion 424, indicating that by switching from a Nafion 115 membrane (127 micrometres thick) to a Nafion 424 membrane (380 micrometres thick) the formic acid crossover was reduced by 62% and the water crossover was reduced by 69% (in these experiments the behaviour of the membranes was investigated without any current flowing in the cell);

FIG. 29 shows the effect of the formic acid concentration on formic acid cross-over—the crossover rate for formic acid increases, plateaus, and then declines as concentration is increased indicating that reducing or increasing formic acid concentration can reduce formic acid cross-over;

FIG. 30 shows formate/formic acid cross-over rate with varying pH of neutralisation chamber solution (noting that these experiments were conducted with no electrical current and noting that at low pH the formic acid is protonated whereas as increased pH close to 3.75 cross-over is reduced as the formic acid deprotonates and won't cross the cation exchange membrane);

FIG. 31 shows cross-over of formic acid into the catholyte (LiOH) was essentially eliminated using a four-chamber configuration comprising a neutralisation chamber (first three columns) compared to a two-chamber test configuration for comparison; and

FIG. 32 shows yet another an example of an electrolysis system, the cell configuration being similar to those shown in FIGS. 9 to 11 but with a “neutralisation chamber” between the diluate and concentrate chambers intended to reduce formic acid cross-over and formic acid oxidation.

### DETAILED DESCRIPTION

As described in the summary section, the present specification provided a method for recycling Li from an input material comprising Li and one or more transition metals, comprising the steps of:
contacting said input material with a leaching medium comprising organic acid (e.g., formic acid);
leaching Li from the input material to form a leachate comprising an organic lithium salt (e.g., lithium formate); and
electrolytically converting the organic lithium salt (e.g., lithium formate) to an inorganic lithium salt (e.g., lithium hydroxide or lithium carbonate).

According to certain embodiments, the electrochemical processing methodologies and cell configurations used for electrolytically converting the lithium formate to lithium hydroxide include the use of one or more membranes which are selective to the transmission of monovalent lithium over multivalent transition metals. In this case, such electrochemical cell configurations and methods are capable of both separating the lithium from multivalent transition metal impurities in the leachate and converting the lithium formate to lithium hydroxide. Alternatively, or additionally, a multivalent metal separation step (such as an ion exchange process) may be applied to the leachate prior to electrolysis. In this case, the use of a selective membrane is not necessarily required in the electrochemical cell configuration which is then only required to convert the lithium formate to lithium hydroxide.

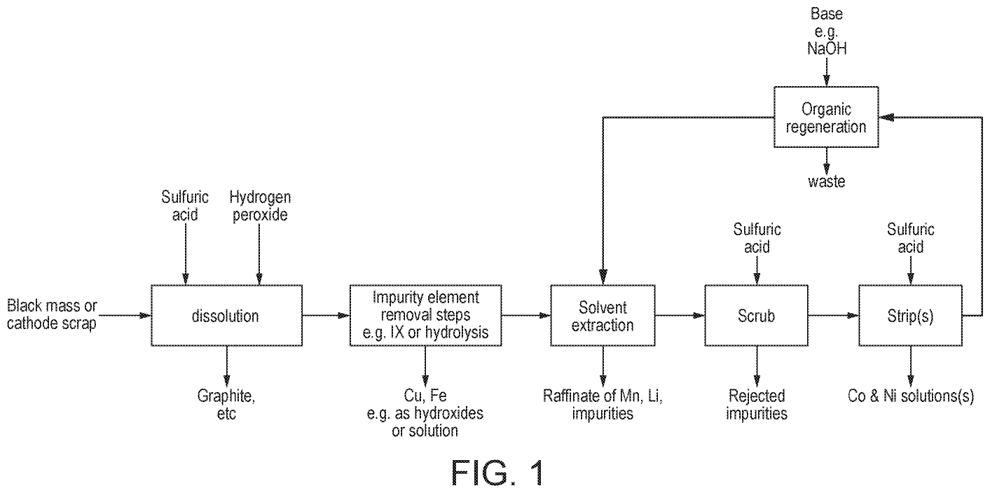

While the method may be applied to recycling of a range of functional input materials, it is particularly useful for lithium ion battery cathode material recycling. In this regard, FIG. 1 shows an example of a battery materials recycling process. The starting material is cathode scrap or so-called “black-mass” which typically comprises Li, Ni, Co, Mn and impurities including Cu and Fe. The material is subjected to an acid dissolution or leaching step to obtain an acidic aqueous recycling feed comprising the constituent metal species in solution. Impurities such as Cu and Fe can be removed by ion exchange or hydrolysis. An organic solvent extraction step can then be applied to separate Co and Ni (in the organic phase) from Mn and Li. An acid scrub can further be applied to the organic phase to remove any impurities prior to stripping of the Co and Ni into aqueous Co and Ni solutions. The organic phase can be regenerated and recycled for use in further extraction of Co and Ni. The method of FIG. 1 enables Co and Ni to be separated from the cathode black mass material. However, further process steps are required if separation of Li and Mn from each other is to be achieved.

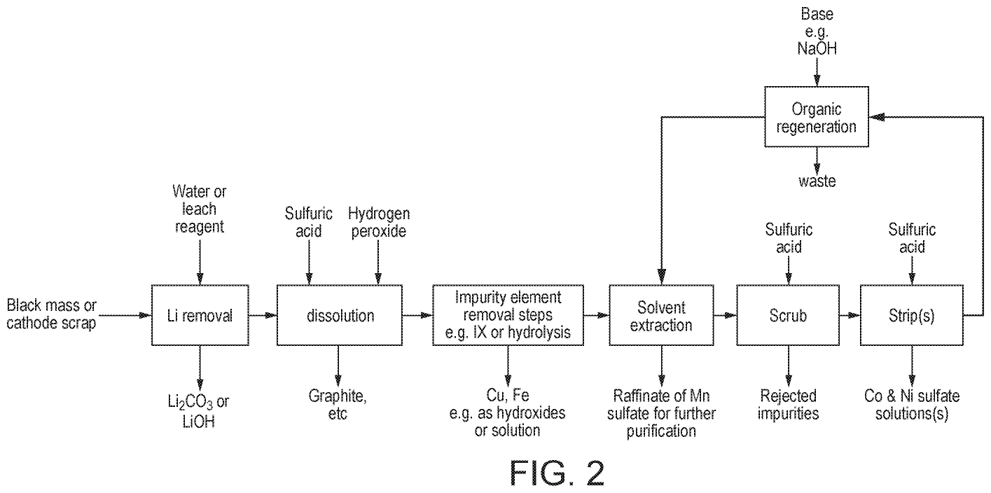

FIG. 2 shows another example of a battery materials recycling process. Again, the starting material is cathode scrap or so-called “black-mass” which typically comprises Li, Ni, Co, Mn and impurities including Cu and Fe. However, in this example, the lithium is removed first by treatment with a suitable solvent (e.g. an organic acid such as formic acid) which dissolves Li but not the other metal species. The remaining material is subjected to an acid dissolution or leaching step to obtain an acidic aqueous recycling feed comprising the remaining constituent metal species in solution. Impurities such as Cu and Fe can be removed by ion exchange or hydrolysis. An organic solvent extraction step can then be applied to separate Co and Ni (in the organic phase) from Mn. An acid scrub can further be applied to the organic phase to remove any impurities prior to stripping of the Co and Ni into aqueous Co and Ni solutions. The organic phase can be regenerated and recycled for use in further extraction of Co and Ni. The method of FIG. 2 is advantageous in that it enables an efficient 4-way separation of Li, Mn, Co, and Ni to be achieved.

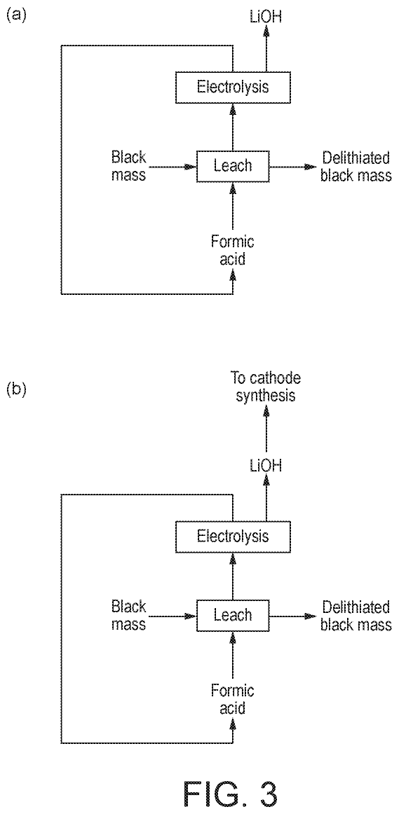

The methodology of the present specification may be applied in the battery materials recycling process of FIG. 2 in which lithium is removed from the black mass by leaching with formic acid. As previously described in the summary section, the selective formic acid leach of lithium from black mass produces a highly concentrated aqueous solution of formic acid mainly containing lithium, accompanied by other metals in lower concentrations. For the lithium extraction approach to be economically and ecologically viable, the lithium formate in this solution should be converted to an inorganic lithium salt (e.g., lithium hydroxide or lithium carbonate) for re-use in lithium ion battery cathode material synthesis and the formic acid should be recycled for re-use in the formic acid leaching step of the recycling process. Such a method according to the present specification is illustrated in FIGS. 3(a) and 3(b). It may be noted that while lithium carbonate can be formed electrochemically in a CO₂ evolution region (4Li⁺+4e⁻+O₂+2CO₂→2Li₂CO₃), the industry of battery cathode material manufacturing is shifting from the use of Li₂CO₃ to LiOH which will become the predominant precursor. Accordingly, the examples in this specification focus primarily on the formation of the lithium hydroxide salt while recognizing that other lithium salts can be formed using the teachings of this specification.

The following description includes a section detailing the formic acid leaching processes described in in the proprietor's earlier GB patent application number 2016329.1 (included in this specification for completeness) followed by sections setting out details of several different methods for performing the electrochemical conversion of lithium formate to lithium hydroxide for re-use in fabricating new functional materials (e.g. lithium ion battery materials).

### Formic Acid Leaching

The formic acid leaching process involves selectively removing Li from an input material comprising Li and one or more transition metals, comprising the steps of:
contacting said input material with a leaching medium comprising formic acid; and
leaching Li from the input material to form a leachate;
   wherein the concentration of formic acid in the leaching medium is at least 40 wt. %.

As previously described, the input material is typically battery scrap, especially cathode scrap from a Li-ion battery or a solid state Li battery. The battery scrap may have been previously used within an electrical energy storage device, although this is not essential. The battery scrap may be waste material generated during the production of batteries or materials, including for example waste intermediate materials or failed batches. In some embodiments, the battery scrap is formed by mechanical and/or chemical processing of waste lithium ion batteries.

In some embodiments, the input material comprises lithium and one or more of iron, nickel, cobalt and manganese. In some embodiments, the input material comprises lithium, nickel and cobalt. In some embodiments the input material comprises lithium, nickel, cobalt and manganese.

As the skilled person will understand, the input material may further comprise other elements and/or materials derived from the electrochemical storage device, such as other elements derived from the cathode material, the current collector, the anode material, the electrolyte and any battery or cell casings.

In preferred embodiments the material comprises one or more of nickel, manganese and cobalt, in addition to Li. In some embodiments the material includes each of nickel, manganese and cobalt, in addition to Li.

The input material may comprise at least 10 wt % Ni based on the total mass of input material, for example at least 12 wt %, at least 15 wt %, at least 20 wt % or at least 25 wt %. The input material may comprise up to 80 wt % Ni based on the total mass of input material, for example up to 75 wt %, up to 70 wt % or up to 50 wt %. The input material may comprise from 10 to 80 wt % Ni based on the total mass of input material.

The input material may comprise at least 0 wt % Mn based on the total mass of input material, for example at least 1 wt %, at least 2 wt %, at least 5 wt % or at least 10 wt %. The input material may comprise up to 33 wt % Mn based on the total mass of input material, for example up to 30 wt %, up to 28 wt % or up to 25 wt %. The input material may comprise from 0 to 33 wt % Mn based on the total mass of input material.

The input material may comprise at least 0 wt % Co based on the total mass of input material, for example at least 1 wt %, at least 2 wt %, at least 5 wt % or at least 10 wt %. The input material may comprise up to 33 wt % Co based on the total mass of input material, for example up to 30 wt %, up to 28 wt % or up to 25 wt %. The input material may comprise from 0 to 33 wt % Co based on the total mass of input material.

The input material may comprise at least 0 wt % Li based on the total mass of input material, for example at least 1 wt %, at least 2 wt %, at least 5 wt % or at least 6 wt %. The input material may comprise up to 20 wt % Li based on the total mass of input material, for example up to 18 wt %, up to 15 wt % or up to 12 wt %. The input material may comprise from 0 to 20 wt % Li based on the total mass of input material.

The input material may comprise at least 0 wt % Fe based on the total mass of input material, for example at least 1 wt %, at least 2 wt % or at least 3 wt %. The input material may comprise up to 10 wt % Fe based on the total mass of input material, for example up to 9 wt %, up to 8 wt % or up to 7 wt %. The input material may comprise from 0 to 10 wt % Fe based on the total mass of input material.

The input material may comprise at least 0 wt % Al based on the total mass of input material, for example at least 1 wt %, at least 2 wt % or at least 3 wt %. The input material may comprise up to 10 wt % Al based on the total mass of input material, for example up to 9 wt %, up to 8 wt % or up to 7 wt %. The input material may comprise from 0 to 10 wt % Al based on the total mass of input material.

The input material may comprise at least 0 wt % Cu based on the total mass of input material, for example at least 1 wt %, at least 2 wt % or at least 3 wt %. The input material may comprise up to 20 wt % Cu based on the total mass of input material, for example up to 15 wt %, up to 10 wt %, ip to 9 wt %, up to 8 wt % or up to 7 wt %. The input material may comprise from 0 to 20 wt % Cu based on the total mass of input material.

The input material may comprise at least 0 wt % C based on the total mass of input material, for example at least 1 wt %, at least 5 wt %, at least 10 wt % or at least 15 wt %. The input material may comprise up to 50 wt % C based on the total mass of input material, for example up to 45 wt %, up to 40 wt % or up to 30 wt %. The input material may comprise from 0 to 50 wt % C based on the total mass of input material.

The input material may comprise from 10 to 80 wt % Ni, from 0 to 33 wt % Mn, from 0 to 33 wt % Co, from 0 to 20 wt % Li, from 0 to 10 wt % Fe, from 0 to 10 wt % Al, from 0 to 10 wt % Cu and from 0 to 50 wt % C based on the total mass of input material.

Two important parameters to consider in a leaching process are the leaching efficiency and the leaching selectivity. The leaching efficiency is the proportion of a given metal in the input material which is leached by the leaching medium. For example, if an input material contains 10 g of Li, and following leaching 9 g of Li has been leached, then the leaching efficiency for Li is 90%.

The leaching selectivity refers to the proportion of a given metal leached relative to the total of metals leached. In the Figures below, leaching selectivity is plotted based on the total molar content of metal ions in the leaching medium. For example, if following leaching the medium includes 0.95 mol Li and 0.05 mol Ni (a total of 1.0 mol metals) then the leaching selectivity for Li is 95%. Leaching selectivity is sometimes reported based on the total wt % of the metals leached, but this can obscure the selectivity because of the low mass of Li compared to other metals.

The process uses a leaching medium comprising formic acid at a concentration of at least 40 wt. %. While the highest selectivity for Li removal is achieved using essentially pure formic acid (98+% formic acid, see examples) and/or using high temperatures, in some embodiments it may be preferable to use a leaching medium of relatively dilute formic acid, e.g. at least 40 wt % formic acid with up to 60 wt % water or at least 50 wt % formic acid with up to 50 wt % water. While such solutions are not as selective for Li removal as 98+% formic acid, their use does not pose such a difficult engineering challenge as compared with highly concentrated formic acid, the latter requiring more expensive plant equipment. The use of a relatively dilute formic acid leaching medium can also be preferably from a safety perspective because of its lower flammability as compared with concentrated formic acid. Manganese salts have been shown to be particularly detrimental to Li leaching selectivity because of their high solubility in aqueous formic acid. The use of relatively dilute formic acid leaching mediums may therefore be particularly tolerated when the substrate is substantially free from Mn.

Typically, the leaching medium will comprise formic acid at a concentration of at least 70 wt %. It has been found by the present inventors that such leaching mediums have a high leaching selectivity for Li. In preferred embodiments the concentration of formic acid in the leaching medium is at least 80 wt %. In preferred embodiments the concentration of formic acid in the leaching medium is at least 90 wt %, such as at least 98 wt % or at least 99 wt %. In general, the higher the concentration of formic acid in the leaching medium the higher the leaching selectivity for Li. A leaching medium of substantially pure formic acid has the advantage of high efficiency for Li removal and high selectivity for Li over other transition metals, particularly Ni, Mn and Co.

In some embodiments the leaching medium is an azeotrope of formic acid and water containing 77.5 wt % formic acid and 22.5 wt % water. As those skilled in the art will appreciate, the azeotrope boils without changing the ratio of formic acid to water. This allows the leaching medium to be more straightforwardly recycled, e.g. by boiling off solvent from the leachate. As formic acid is consumed during the leaching process (e.g. through the production of lithium formate), a recycling loop will generally include steps to ensure that the azeotrope composition is maintained in the reactor, e.g. by adding fresh leaching medium with a concentration of formic acid greater than that in the azeotrope.

In some embodiments the leaching medium comprises H₂O₂. In addition to the formic acid, H₂O₂ helps to reduce transition metals in the input material (e.g. from the +3 or +4 oxidation states to the +2 oxidation state). When present in the leaching medium, the concentration of H₂O₂ in the leaching medium is preferably in the range of 1-10 wt. %, preferably 3-7 wt. %. Lower H₂O₂ concentrations are desirable from a safety perspective.

To ensure efficient contact between the leaching medium and input material in some embodiments leaching may be carried out with agitation of the substrate, for example using stirring or ultrasound.

It has been established that in general, the higher the temperature during the leaching process the higher the leaching efficiency and leaching selectivity. It is preferred that during the leaching process the mixture of leaching medium and input material is heated to a temperature of at least 40° C. Typically, the temperature during the leaching process will be at least 60° C. in order to achieve high leaching efficiency. Preferably the temperature during the leaching process will be at least 80° C., in some embodiments at least 90° C. In some embodiments the mixture is heated at or above the boiling point of the leaching medium, for example under reflux.

The duration of heating should be sufficient to remove substantially all of the Li from the input material. This may depend in part on the temperature of the leaching medium and the physical form and chemical nature of the input material. Unnecessarily long durations are disfavoured on cost grounds. Suitable durations will readily be ascertained by those skilled in the art. When leaching is run as a batch process a typical duration of heating is 5-120 minutes, preferably 5-60 minutes.

The input material is typically contacted with the leaching medium at room temperature or above and then heated to the desired temperature. In some embodiments the leaching medium may be pre-heated before being contacted with the input material, without further heating of the mixture. Alternatively, the leaching medium may be at ambient temperature when contacted with the input material, and the mixture then heated to the desired temperature. It is also possible for the leaching medium to be pre-heated before being contacted with the input material, and the mixture then heated up further to the desired temperature.

An important parameter in a leaching process is the ratio of solid input material to leaching medium, referred to as S/L. During the leaching process, metals are dissolved into the leaching medium as the metal formates, of which Li formate is the most soluble. The formation of metal formates is also associated with the production of water (e.g. where the substrate is a metal oxide) which dilutes the leaching medium.

The use of a high S/L ratio is favoured on a number of grounds including: lower required volumes of leaching medium, meaning lower raw material costs, lower plant operation costs and reduced volumes of waste. At high S/L ratios the resulting leachate has a high concentration of lithium formate, which helps to suppress the dissolution of less soluble metal formate salts, e.g. of Mn, Ni or Co. On the other hand, at high S/L ratios the leaching medium is more prone to dilution from water formed as a by-product of the leaching process, which in unfavourable to leaching selectivity. In general, it is preferred that the S/L ratio is at least 10 g/L, preferably at least 20 g/L, more preferably at least 30 g/L. A typical range of values for S/L are 10-150 g/L, such as 20-150 g/L, such as 30-150 g/L.

In some embodiments additives may be added to the leaching medium to further prevent leaching of transition metals in the input material and thereby to improve the leaching selectivity for Li. The use of additives may be particularly appropriate when the S/L ratio is high and/or the leaching medium has a relatively low concentration of formic acid. The nature of the salt is not particularly critical, provided that it has a high solubility in the leaching medium and does not interfere with the leaching of Li or disrupt downstream steps. A preferred class of salts are sulphates, which have been found by the present inventors to prevent the leaching of transition metals, particularly Mn. The nature of the counterion in the sulphate salt is not particularly critical, but in order to avoid unnecessarily contaminating the leaching medium with additional metals, it is preferred that the counterion is a non-metal. A preferred additive is ammonium sulphate. The additives may be added to the leaching medium either before or after contacting with the input material. Typically, the additive will be added to the leaching medium in an amount of 10-100 g/L, such as 20-80 g/L or 20-50 g/L, these values being particularly suitable in the case of ammonium sulphate.

The process described herein results in the selective leaching of Li from the input material. Without wishing to be bound by theory, it is thought that initially the formic acid (and H₂O₂ if present), reduces metal ions in the input material, allowing Li ions to dissolve into the leaching medium. The resulting output material is a transition metal oxide. Over time, it is thought that this reacts with the excess of formic acid to produce the corresponding metal formate salt and water. The metal formate salts remain solid due their poor solubility in the leaching medium.

### Examples for Formic Acid Leaching

### Materials

NMC 111—supplier Targray.
Formic acid—98% grade Fisher Scientific.
Ammonium sulphate—supplied by Acros Organics.
Lithium Nickel Cobalt Oxide cathode material, available from Johnson Matthey Plc under trade name eLNO™.

### Example 1 (98 wt % formic acid+NMC 111)

2 g NMC 111 was added to 50 mL formic acid in a 100 mL round bottom flask equipped with a condenser. The suspension was stirred at 500 rpm, while the solution was heated to boiling (approx. 103° C.), typically requiring the heating plate to be set to 130° C. After 1 h, the solution was filtered and the leachate was analysed for elemental analysis using ICP-OES.

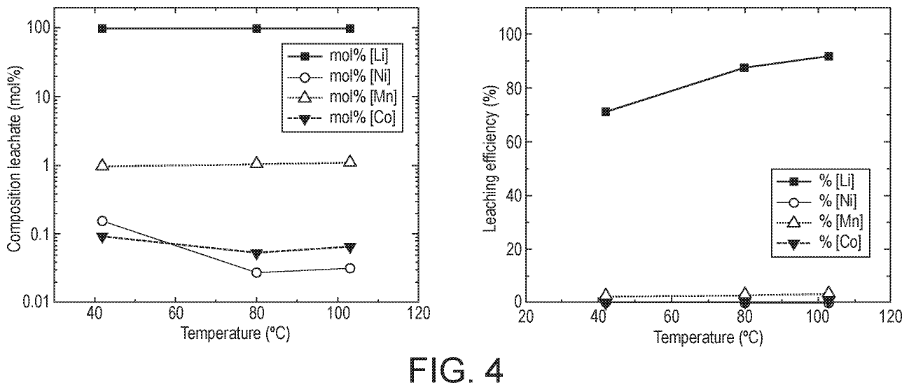

FIG. 4 shows that within 1 h, >90% Li was leached from the NMC 111, and Li accounted for >90 wt % of metals in the leachate. The leaching efficiency for Li increased as temperature was increased, without any sign of changes in leaching selectivity. Only a small amount of Mn dissolved into the leaching medium under each of the conditions, which increased slightly with increasing temperature. The leaching of Co and Ni was negligible.

### Example 2 (98 wt % Formic Acid+NMC 111+(NH₄)₂SO₄)

The procedure of Example 1 was followed but 2 g of (NH₄)₂SO₄ was added to the leachate.

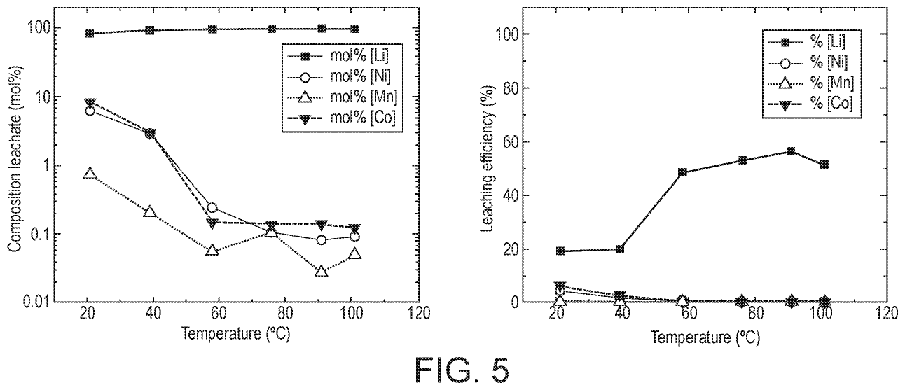

FIG. 5 shows that while leaching efficiency was not as high as for Example 1, at temperatures of 60° C. or above the leaching selectivity was higher than for Example 1, with hardly any leaching of Ni, Co or Mn.

### Example 3 (77.5 wt % Formic Acid/22.5 wt % H2O+NMC 111)

The procedure of Example 1 was followed using 50 mL of an azeotrope of formic acid and water (77.5% formic acid and 22.5% H₂O) in place of the 50 mL of formic acid.

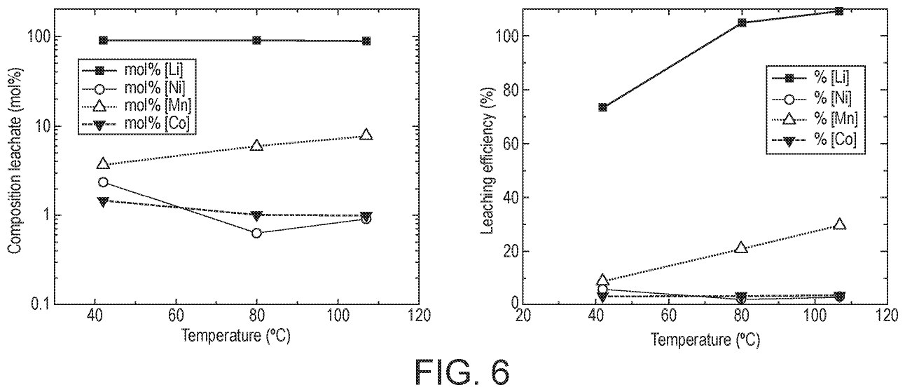

FIG. 6 shows that the use of a formic acid/water azeotrope as leaching medium still offered high leaching efficiency, although the leaching selectivity was not as high as when using 98% formic acid. The leaching of Mn(II) ions was significant, especially as the temperature was increased.

### Example 4 (77.5 wt % Formic Acid/22.5 wt % H₂O+NMC 111+(NH₄)₂SO₄)

The procedure of Example 3 was followed but 2 g (NH₄)₂SO₄ was added to the leaching medium.

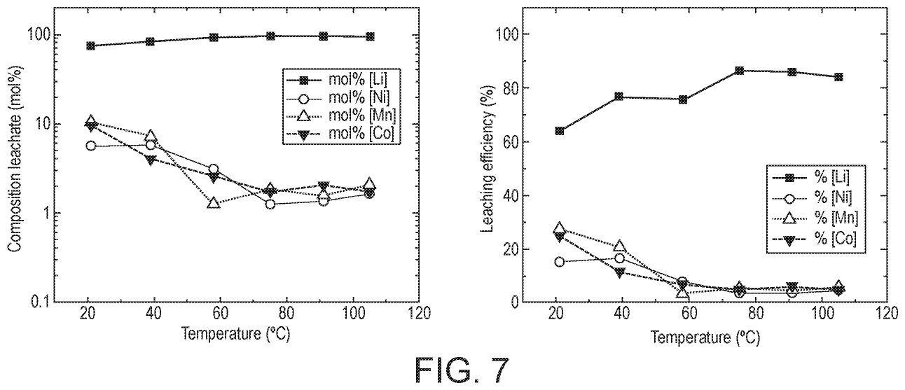

FIG. 7 shows that relative to the use of a formic acid/water azeotrope alone (Example 3), the inclusion of (NH₄)₂SO₄ resulted in a higher selectivity for Li, with a lower concentration of undesired metal ions in the leachate. In particular, the leaching of Mn was suppressed.

### Example 5 (50 wt % Formic Acid/45 wt % H₂O+5% H₂O₂+eLNO)

The procedure of Example 1 was followed but the leaching medium was a mixture of 50 wt % formic acid, 45 wt % water and 5 wt % H₂O₂, and 2 g lithium nickel cobalt oxide cathode material was used instead of 2 g of NMC 111.

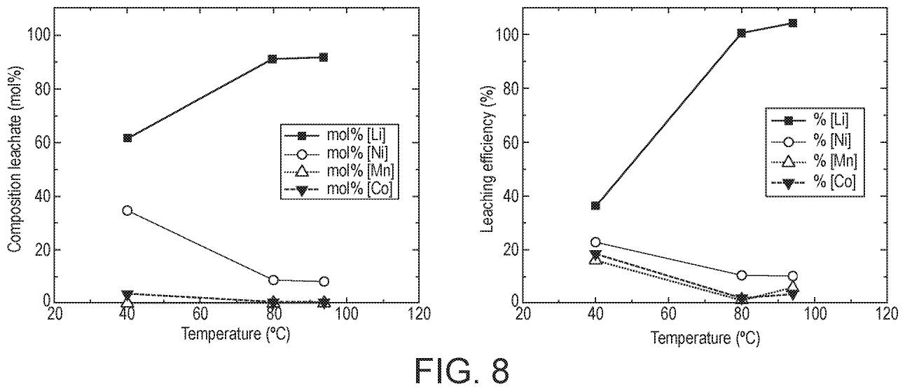

FIG. 8 shows that a high efficiency and relatively high selectivity of Li can be achieved using diluted performic acid as a leaching medium, although the leaching selectivity was not as high as for Examples 1-4 which used a more concentrated leaching medium.

### Electrolysis of Lithium Formate to Produce Lithium Hydroxide

The selective formic acid leach of lithium (e.g. from black mass) as described in the previous section produces a concentrated aqueous solution of formic acid mainly containing lithium, accompanied by other metals in lower concentrations. For this lithium recycling approach to be economically and ecologically viable, the lithium formate in this solution must be converted to lithium hydroxide for lithium ion cathode material synthesis and the formic acid must be recycled for reuse in the leach. It has been found that while lithium sulfate can be electrolysed to lithium hydroxide and sulfuric acid using a relatively standard two-chamber electrolyser, using such an approach for electrolysing lithium formate to lithium hydroxide is not optimal due to oxidation of formate at the anode. As such, a modified electrochemical methodology is desired for providing a more efficient and sustainable method of electrolysing lithium formate to lithium hydroxide. Several such modified approaches are described below.

### Two Chamber Bipolar Membrane Salt Splitting Electrolysis of Lithium Formate to Lithium Hydroxide and Formic Acid

This approach provides an integrated process for converting the lithium formate contained in a formic acid leach liquor of lithium ion battery black mass into solid lithium hydroxide, while regenerating formic acid for reuse in the leach. It centres on a two-chamber salt splitting electrolysis which uses bipolar membranes rather than electrodes on either side of a cation exchange membrane as the repeating unit in the cell stack. The use of bipolar membranes allows the majority of protons formed in the electrolysis to be generated by water dissociation rather than water oxidation and so significantly reduces the rate of formic acid oxidation. The process also advantageously comprises a selective precipitation of lithium hydroxide from a mixed hydroxide/formate solution. The method also advantageously uses a pH gradient across the cation exchange membranes to significantly reduce the flux of multivalent elements from the formic acid leach liquor to the LiOH, and a membrane stripping process in which these impurities are removed by flowing >3 M sulfuric acid solution through the cell. Alternatively, if specialised monovalent selective cation exchange membranes are used then monovalent selectivity can be based on 2+ charge repulsion rather than a pH gradient.

According to the approach set out in this section, a 2-chamber electrolysis system is provided that allows lithium formate containing solutions to be electrolysed in a salt splitting electrolysis to give formic acid and lithium hydroxide without significant oxidation of formate to CO₂ at the anode. The overall salt splitting reaction is as follows:

LiCHOO+1.5H₂O-->LiOH+HCHOO+(¼O₂(g)+½H₂(g).)

The reaction is driven by applying a current between the anode and cathode of the cell. The applied current can be a constant current or can be varied in operation to control the reaction. It should also be noted that the stoichiometry for the gasses indicated in the equation is correct for the situation when no bipolar membranes are used, and faradaic efficiency is 100%, and will be varied when using such bipolar membranes.

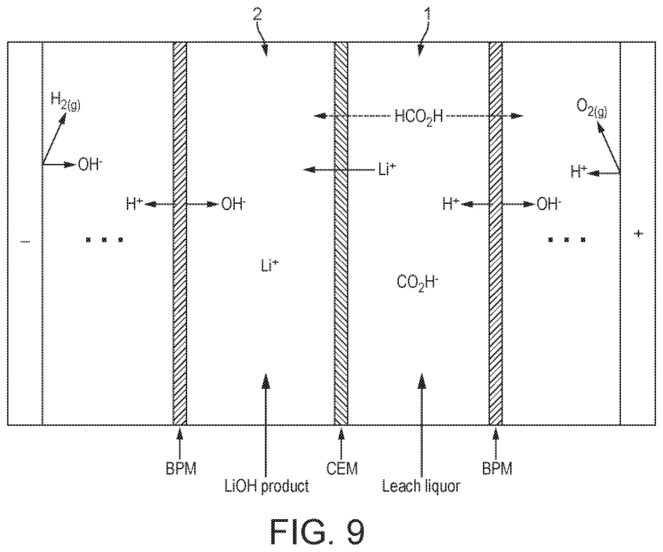

A diagram of the cell configuration is shown in FIG. 9. The configuration comprises two chambers 1, 2. The two chambers 1, 2 are repeated in a stack between the anode and cathode as indicated in FIG. 9 by “ . . . ”. The two chambers 1, 2 are separated by a cation exchange membrane (OEM) on a cathode side of chamber 1 and a bipolar membrane (BPM) on an anode side of chamber 1. Formic acid leach liquor containing lithium formate is pumped through chamber 1. Lithium cations in chamber 1 pass through the cation exchange membrane into chamber 2 at the cathode side of chamber 1 where they combine with hydroxide anions formed by water dissociation in the bipolar membrane to form lithium hydroxide. Hydroxide anions in chamber 1 are formed in and migrate through the bipolar membrane towards the anode on the anode side of chamber 1 while protons are formed in and migrate through the bipolar membrane into chamber 1 on the anode side of chamber 1.

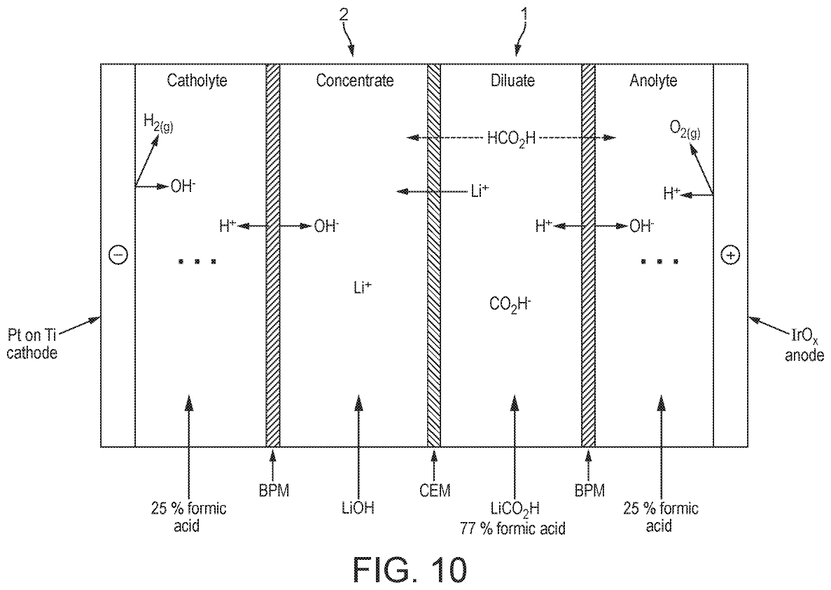

FIG. 10 shows an example of the electrochemical cell configuration shown in FIG. 9. In the example of FIG. 10, the anode is an iridium oxide-based anode while the cathode is a platinum-based cathode, although it should be noted that other anode and cathode materials can be utilized. A 77% formic acid leach liquor is indicated as being pumped into chamber 1 (diluate) with lithium hydroxide being formed in chamber 2 (concentrate). Again, the two chambers 1, 2 are repeated in a stack between the anode and cathode as indicated by “ . . . ”. In the example illustrated in FIG. 10, 25% formic acid is pumped through the anolyte chamber adjacent the anode and 25% formic acid is also pumped through the catholyte chamber adjacent the cathode. However, the anolyte and catholyte, i.e. the electrolytes that are actually in direct contact with the anode and cathode could actually be the same lithium hydroxide solution that is being circulated through the “concentrate” chambers. Indeed, the electrolytes that are actually in direct contact with the anode and cathode could be any conductive electrolytes for which there is no issue with their components crossing over the bipolar membranes into the LiOH or leach liquor streams.

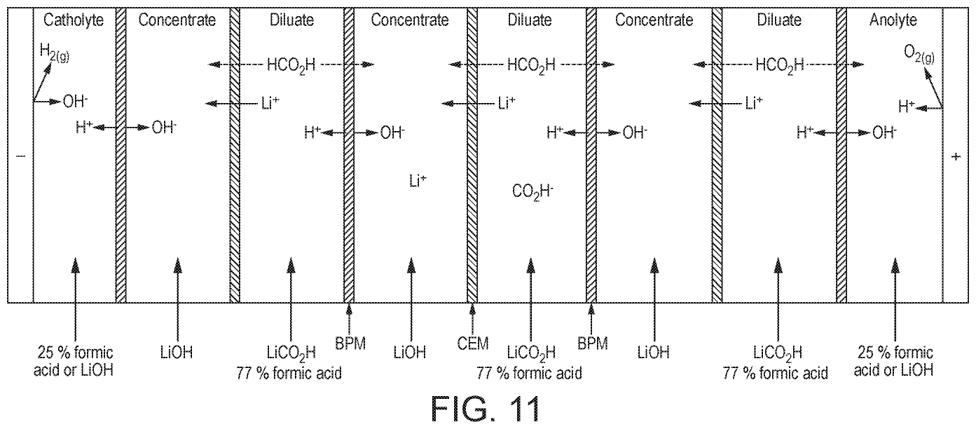

The full-scale cell configuration is a “stack” in which several repeating units sit adjacent to each other between the anode and cathode. The repeating unit consists of a cation exchange membrane between two bipolar membranes. FIG. 11 shows an expanded version of the electrochemical cell configuration shown in FIG. 10 to clarify the repeating structure. In the 2-chamber repeating unit, the lithium formate containing solution may be circulated through the chamber closest to the anode and an LiOH solution may be recirculated through the chamber on the other side of the cation exchange membrane, closest to the cathode. However, it may be noted that advantageous formates should be kept apart from anodic parts of the cell where they can be oxidized and lost.

At the anode, the anodic water splitting reaction (H₂O-->½O₂+2H⁺+2e⁻) produces protons and at the cathode, the cathodic water splitting reaction produces hydroxide ions (H₂O+2e⁻-->2OH−+½H₂(g)) The bipolar membranes split water without producing gasses through water dissociation (at each side of adjacent anion and cation exchange layers of the bipolar membrane): H₂O-->H⁺+OH⁻.

There can be as many as 2, 4, 6, 8, 10, 15, 20 or more repeating 2-chamber units in a stack between an anode and a cathode electrode. Therefore, the majority of protons and hydroxide ions will be formed in the bipolar membranes rather than at the electrodes. By mainly generating protons by dissociation rather than water oxidation, the rate of formic acid oxidation is significantly reduced. If all protons were generated at anodes, the formic acid in contact with the anodes would preferentially oxidise over water.

When a current is applied to the cell, Li⁺ ions and protons migrate across the cation exchange membrane into the LiOH electrolyte. The charge of the new Li+ions is balanced by that of the newly created OH⁻ ions from the bipolar membrane. The Li⁺ ions leave behind formate anions on the other side of the membrane and these have their charges balanced by the protons generated by the other bipolar membrane. In this way, formic acid is regenerated as LiOH is produced. Alternatively, Li⁺ ions migrate into the cathode compartment where they react with OH⁻ ions created by the bipolar membrane, whereas formate anion react with H⁺ generated at the other side of the bipolar membrane.

Multivalent cations such as Cu²⁺ or Mn²⁺ may be present in the lithium formate containing solution. However, the pH gradient across the cation exchange membrane (acidic on the formate side and basic on the LiOH side) means they will not be able to cross the membrane at the same rate as Li⁺. This is because at high pHs, the multivalent metals are too strongly bound to the cation exchange membrane's anionic (e.g. sulfonate) functional groups to be mobile, whereas lithium is less strongly bound and so can move across. This means that, after some time, the cation exchange membranes can become blocked with multivalent metals and will need to be stripped by flowing, for example, sulfuric acid through the cell (e.g. >2-molar sulfuric acid).

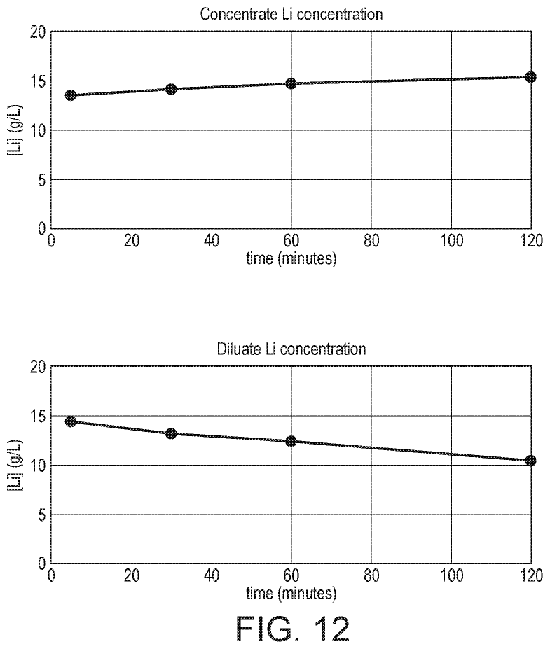

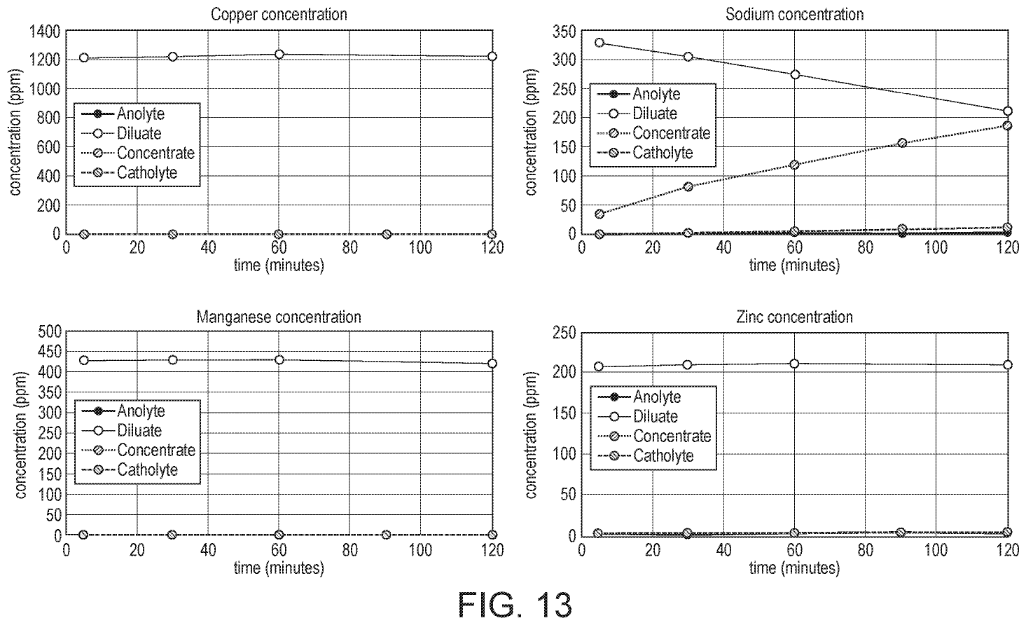

FIG. 12 shows results for a four-chamber cell configuration of FIG. 9, indicating a decrease in lithium concentration in the diluate and an increase in the lithium concentration in the concentrate over time with a cell configuration in which 25% formic acid was used as anolyte and catholyte and bipolar membranes were provided either side of a cation exchange membrane forming diluate and concentrate chambers between the anolyte and catholyte. The formic acid concentration in the diluate was 40% in this experiment. FIG. 13 shows results of the same cell set-up of FIG. 12, indicating selected elements in the four-chamber experiment and showing that the central cation exchange membrane (e.g. Nafion 424) is monovalent selective under these conditions. It is also evident that the bipolar membranes prevent the metals entering the anolyte and catholyte (although a small amount of sodium does cross over).

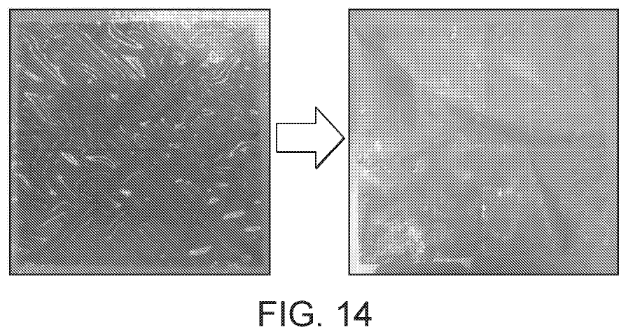

FIG. 14 shows a Nafion N115 cation exchange membrane which has become loaded with multivalent metals (left hand side) and the same membrane after being stripping with 8 M H₂SO₄ (right hand side) to illustrate the stripping process. As an alternative to chemical stripping, it is also possible to remove multivalent metal impurities built up on membrane components by periodically reversing the cell current although care must be taken to avoid delamination of the bipolar membranes using this approach.

Formic acid (especially when at high concentrations) is able to cross over both the cation exchange membrane and the bipolar membranes as an associated neutral molecule. When it travels over the membranes from the lithium formate containing electrolyte to the LiOH electrolyte, it reacts with LiOH to form lithium formate. Since LiOH is the desired product, it is then necessary to separate lithium hydroxide from lithium formate.

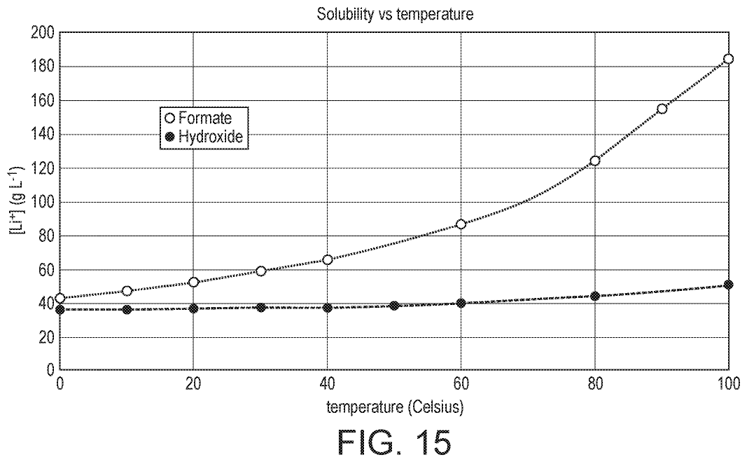

Lithium hydroxide and lithium formate can be separated by selectively precipitating LiOH at high temperature (i.e. by boiling down the solution, or precipitating by other evaporative methods above 80° C.). FIG. 15 shows the solubility of lithium formate and lithium hydroxide versus temperature − at 100° C. lithium formate is 3.6 times more soluble than lithium hydroxide indicating that precipitation can be selective at high LiOH recoveries from solution, i.e. selective precipitation of hydroxide from formate mixture.

The LiOH precipitate can then be washed with saturated and hot LiOH solution to remove remaining formate. The formate containing supernatants and wash solutions can then be recirculated back into the LiOH containing chambers of the cell. There is, however, also a bleed of the supernatant provided from the precipitation into the formate containing chambers of the cell. The purpose of this is to provide an outlet for formate which would otherwise build up in the LiOH stream, and furthermore allow the “crossed over” formate to be regenerated to formic acid.

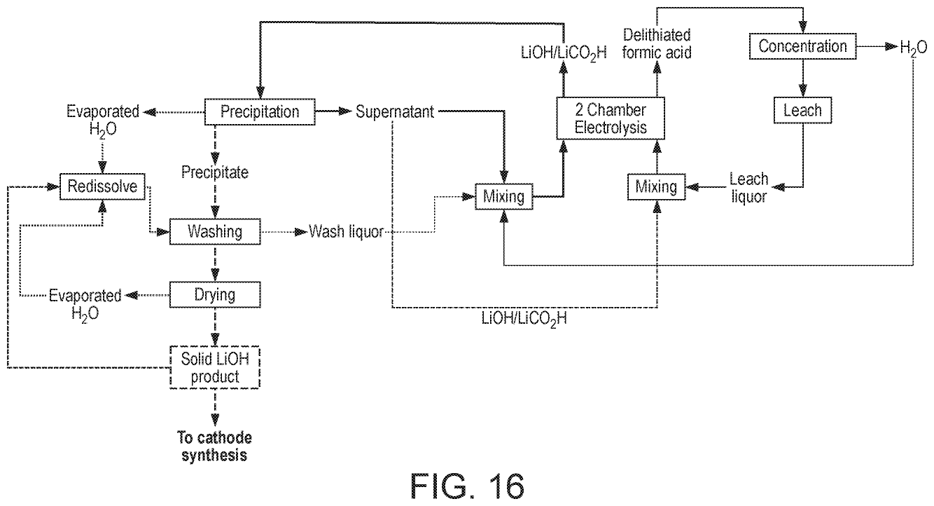

FIG. 16 shows an example of a full process flow diagram for the electrolysis of lithium formate to produce lithium hydroxide including recirculation of formic acid through the leaching process, and precipitation and washing of lithium hydroxide product including recirculation of supernatant and wash liquor. The process has been designed for the context of recovering lithium as LiOH from a formic acid leach liquor of lithium ion battery “black mass”. By regenerating the formic acid used in the leach, it is possible to significantly reduce the quantity of formic acid consumed by the process as well as the quantity of effluent produced. The benefit of using bipolar membranes is that the rate of formic acid oxidation is significantly decreased which means less CO₂ is produced directly through oxidation. Assuming the electricity supplied to the electrolysis is renewable, regenerating formic acid in the electrolysis will improve the climate impact of the plant. Bipolar membranes also allow protons and hydroxide to be produced without hydrogen and oxygen gas, and therefore using them typically lowers the energy consumption of the process. Significantly reducing hydrogen production rate also has clear environment health and safety benefits. Furthermore, the benefit of integrating a selective precipitation into the electrolysis is that it allows the formate which crosses over the cation exchange and bipolar membranes to be separated from the LiOH produced, while also allowing the “crossed over” formate to be regenerated to formic acid.

Typical diluate feeds to be processed using this methodology include one, more or all of Mn, Cu, Fe, Al, Zn, Mg, Na, Ni, Co. Elements in diluate feed below 4 g L⁻¹ may include Mn and/or Cu. Elements in diluate feed below 2 g L⁻¹ may include Fe, Al, Zn, Mg, Na, Ni, and/or Co.

Typical operating conditions include one or more of the following:
Input formic acid concentration: at least 10%, 20%, 30%, 40%, 45% or 50% by volume; no more than 95%, 90%, 85%, or 80% by volume; or within a range defined by any combination of the aforementioned lower and upper limits. For example, within a range of 50% to 85% by volume, e.g. 70% by volume.
Input Li concentration (diluate): at least 0.5, 1, 2.5, 5, or 10 g L⁻¹ Li; no more than 90, 70, 50, 40, 35, 25, or 20 g L⁻¹ Li; or within a range defined by any combination of the aforementioned lower and upper limits. For example, within a range of 2.5 g L⁻¹ Li⁺ to 35 g L⁻¹ Li⁺, e.g. 12.5 g L⁻¹ L⁺.
Anolyte/catholyte formic acid concentration: at least 0%, 2%, 5%, 10%, 15%, or 20% by volume; no more than 80%, 50%, 35%, or 30% by volume; or within a range defined by any combination of the aforementioned lower and upper limits. For example, within a range of 10% to 50% by volume, e.g. 25% by volume.
Output LiOH concentration: at least 2, 4, 6, 8, or 10 g L⁻¹ Li⁺; no more than 40, 30, 20, or 15 g L⁻¹ Li⁺; or within a range defined by any combination of the aforementioned lower and upper limits. For example, within a range of 10 g L⁻¹ Li⁺ to 35 g L⁻¹ Li⁺, e.g. 10 g L⁻¹ Li⁺.
Current density: at least 10, 20, 30, or 40 mA cm⁻²; no more than 1000, 500, 400, 300, 200, or 100 mA cm⁻²; or within a range defined by any combination of the aforementioned lower and upper limits. For example, within a range of 10 mA cm⁻² to 1000 mA cm⁻².

In the experiments supporting this specification the cell was operated at a voltage of 13.5 V, an electrolyte flow rate or 0.3 L minute⁻¹, and an electrolyte volume of 0.27 L.

Three Chamber Electrolysis that Allows Lithium Formate Containing Solutions to be Electrolysed to Produce Formic Acid and Lithium Hydroxide without Significant Oxidation of Formate to CO₂

In this approach a three-chamber electrolysis is provided that allows lithium formate containing solutions to be electrolysed to produce formic acid and lithium hydroxide without significant oxidation of formate to CO₂. A lithium formate solution is split into lithium hydroxide and formic acid. The lithium formate solution is circulated through a central chamber while an electric current is applied to the cell. Lithium ions cross a cation exchange membrane from the central chamber into a cathode chamber to form lithium hydroxide. Electrically generated protons from water splitting at the anode diffuse through a lithium sulfate/sulfuric acid solution and cross a cation exchange membrane from an anode chamber to the central chamber where they balance the charge of the formate ions left in solution to form formic acid. The use of a cation exchange membrane and lithium sulfate/sulfuric acid solution as an electrolyte between the lithium formate solution and the anode blocks diffusion of formate ions and formic acid and so reduces oxidation of formate at the anode.

This approach provides an alternative methodology to that described in the previous section for recovering lithium which has been selectively leached from lithium ion battery black mass. Particularly it recovers this lithium in the form of lithium hydroxide, which is used as a precursor for lithium ion battery cathode material synthesis and which can be easily converted to lithium carbonate (the other main lithium precursor) by reaction with CO₂. As with the previous approach, the method allows formic acid to be regenerated without significant loss of formate to oxidation at the anode. This means the formic acid can be recycled for reuse in a selective leaching step.

One benefit of this approach it uses durable cation exchange membranes and does not require the use of bipolar membranes. Another benefit is that the method can provide a lithium purification process if impure lithium formate containing multivalent metals is fed into the central chamber. Yet another benefit of this method is that the cell setup couples well to a leaching step. In cells using an anion exchange membrane, the formic acid regenerated is recovered in a different solution to the input stream, which can result in a significant volume of lithium depleted solution as a waste stream. In this method the acid is recovered in the initial input solution so that the same volume of solution can be recirculated to the leach and there are no waste streams. It should be noted that this benefit is also true of the previous 2-chamber cell configuration discussed in this specification.

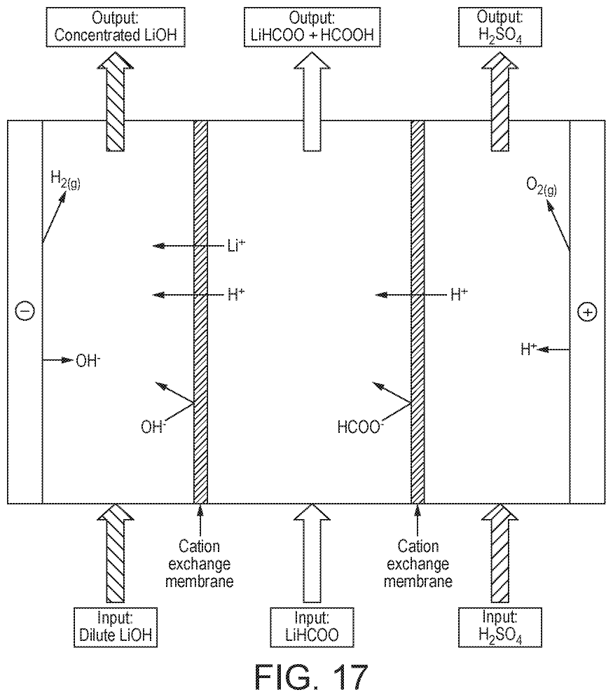

FIG. 17 shows an example of a 3-chamber electrolysis system that allows lithium formate containing solutions to be electrolysed in a salt splitting electrolysis to give formic acid and lithium hydroxide without significant oxidation of formate to CO₂ at the anode. The overall salt splitting reaction is: LiCHOO+1.5H₂O--≥LiOH+HCHOO+¼O₂(g)+½H₂(g). The reaction is driven by applying a constant current between the anode and cathode of the cell (however the current may be periodically and momentarily reversed to remove impurities from one of the cation exchange membranes). The lithium formate containing solution is recirculated through the central chamber between two cation exchange membranes which selectively block the transport of the formate anion but allow cations such as Li⁺ and H⁺ to travel through. The electrolyte in the central chamber will be referred to as the “diluate”.

To a lesser extent the cation exchange membranes also block the transport of neutral associated formic acid molecules from the central chamber. A lithium sulfate and/or sulfuric acid solution is recirculated through the anode chamber, which is separated from the central chamber by a cation exchange membrane. The electrolyte in the anode chamber is called the “anolyte”.

If a two chamber electrolysis cell was used and the lithium formate solution was recirculated through the anode chamber, formate ions would oxidise to CO₂ at the anode and therefore formic acid could not be efficiently produced. However, in the three-chamber setup, the cation exchange membrane acts as a barrier. The purpose of the anolyte is therefore just to be a conductive and electrochemically stable electrolyte which allows protons produced in the anodic water splitting reaction (H₂O(l)--≥2H⁺(aq)+½O²(g)+2e⁻) to travel from the anode to the cation exchange membrane, which they cross into diluate.

Recirculating through the cathode chamber is the catholyte, which is an LiOH solution. The current applied to the cell drives Li⁺ ions across the cation exchange membrane from the diluate to balance the charge of the OH⁻ ions created by the cathodic water splitting reaction (2H₂O(l)+2e⁻-->2OH⁻(aq)+H₂(g)) thereby forming LiOH.

As with the previously discussed 2-chamber cell configuration, the process can be run in batch or continuous flow mode, with continuous flow mode being preferred for both cell configurations. In continuous flow mode, fresh lithium formate containing solution is bled into the recirculating diluate and lithium depleted and acidified diluate is bled out such that the total volume, acidity and lithium concentrations remain constant (i.e. steady state operation). Likewise, water (or supernatant and wash solution as shown in FIG. 16) is bled into the catholyte at a rate that allows the lithium concentration to remain constant and the electrolyte is bled out at a rate that conserves total catholyte volume.

It has been found experimentally that when sulfonic acid cation exchange membranes are used, multivalent metals present in the diluate are selectively blocked from crossing the membrane into the catholyte and anolyte compared to lithium. The selectivity is enhanced by the pH gradient across the membrane from diluate to anolyte, which causes the multivalent metals to become “stuck” in the membrane due to their stronger interaction with the sulfonate groups compared to lithium. This means that the process also acts as a lithium purification process as the purity of the LiOH will be higher than the input lithium formate solution. The multivalent metals can be removed from the membrane to stop it from becoming blocked by stripping with acid or briefly and periodically reversing the direction of the current to drive them down the pH gradient and back into the diluate.

This electrolysis process can be integrated into a lithium ion battery recycling process or flowsheet if the feed into the diluate is a leach liquor from a selective formic acid leach of lithium ion battery black mass. In this case, the regenerated formic acid produced in the electrolysis can be reused in the leaching of the black mass. More generally, the process can be used to recover metals in hydroxide form from organic salts while regenerating organic acids without oxidising the organic anion at the anode and while avoiding the use of anion exchange membranes or bipolar membranes.

The cell setup shown in FIG. 17 has three recirculating electrolytes. During electrolysis, lithium in the diluate (central chamber), which is the formic acid leach liquor (e.g. 50% by volume), crosses the cathode side cation exchange membrane to balance the charge of hydroxide ions created by the cathodic water splitting reaction, and thereby forms LiOH. Li⁺ ions leave behind formate ions, the negative charge of which is balanced by protons diffusing across the anode side cation exchange membrane from the anolyte, where they are created in the anodic water splitting reaction. The anolyte is sulfuric acid and its only purpose is to be a conductive medium through which protons can diffuse. The purpose of the cation exchange membrane between the anolyte and diluate is to block formate ions from diffusing into the anolyte where they would oxidise. In the experimental setup three peristaltic pumps recirculate the electrolytes.

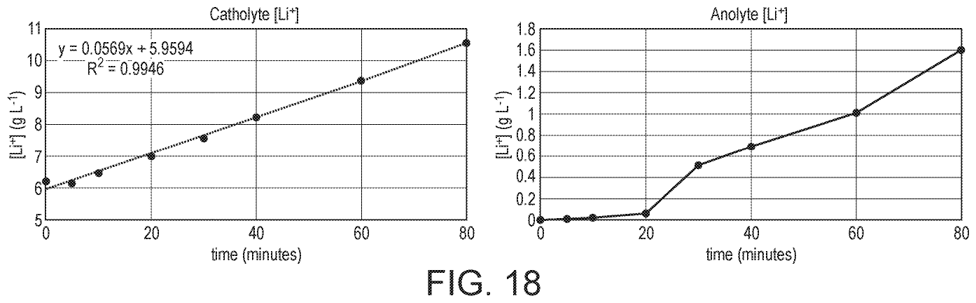

FIG. 18 shows the change in concentration of lithium in the catholyte and anolyte over the electrolysis. As expected, the lithium concentration rapidly increases in the catholyte. Lithium also migrates to the anolyte, moving in the opposite direction to the current and, unlike in the catholyte, the concentration changes nonlinearly. Diffusion to the anolyte against the current is likely due to the large concentration gradient, since the adjacent diluate starts with a concentration of 14.3 g L⁻¹. This is not a problem since in continuous operation the anolyte will reach a steady state lithium concentration at which the driving force from the concentration gradient equals the opposing driving force of the cell voltage. Over eighty minutes the lithium concentration in the diluate decreased from 14.3 to 8.0 g L⁻¹.

While the formic acid leach is selective for lithium, other metals are expected to be present in low concentrations. Previous experiments in sulfate media have shown the Nafion 115 membrane to be very selective for singly charged cations such as Li⁺ over multivalent metals such as Ni²⁺. However, it was not known if the presence of formic acid would affect the membrane's selectivity and so the electrolysis was re-run with the diluate spiked with impurities. The composition of the resulting liquor, which was 50% formic acid by volume, is shown in the table below.

The concentration of elements in the synthetic leach liquor was as follows:

| | Conc. (ppm) | | Conc. (ppm) | | Conc. (ppm) |
|---|---|---|---|---|---|
| L | 9993 | Fe | 331 | Na | 475 |
| Al | 53 | Mg | 137 | Ni | 237 |
| Co | 89 | Mn | 215 | Zn | 221 |
| Cu | 340 | | | | |

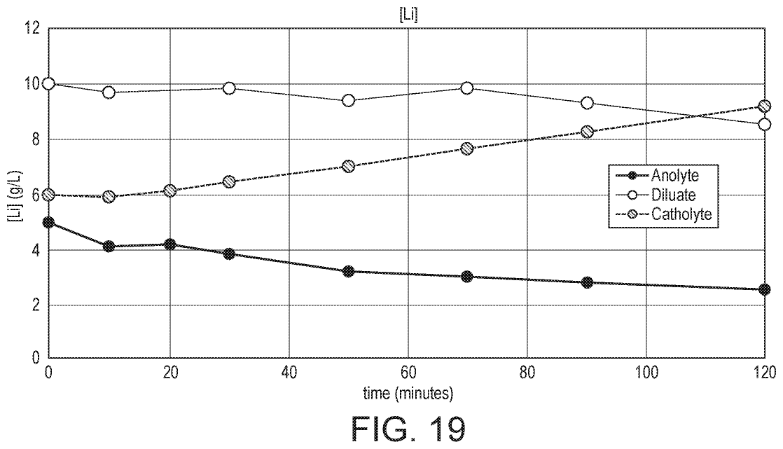

FIG. 19 shows the change in concentration of lithium in the anolyte, diluate and catholyte with time. FIG. 19 shows that while lithium was transferred from the diluate to the catholyte it was also transferred from the anolyte to the diluate. The transfer of lithium from anolyte to diluate was slower than the transfer in the opposite direction. However, it seems that a steady state electrolysis study is the only way to run the system with a constant lithium anolyte concentration.

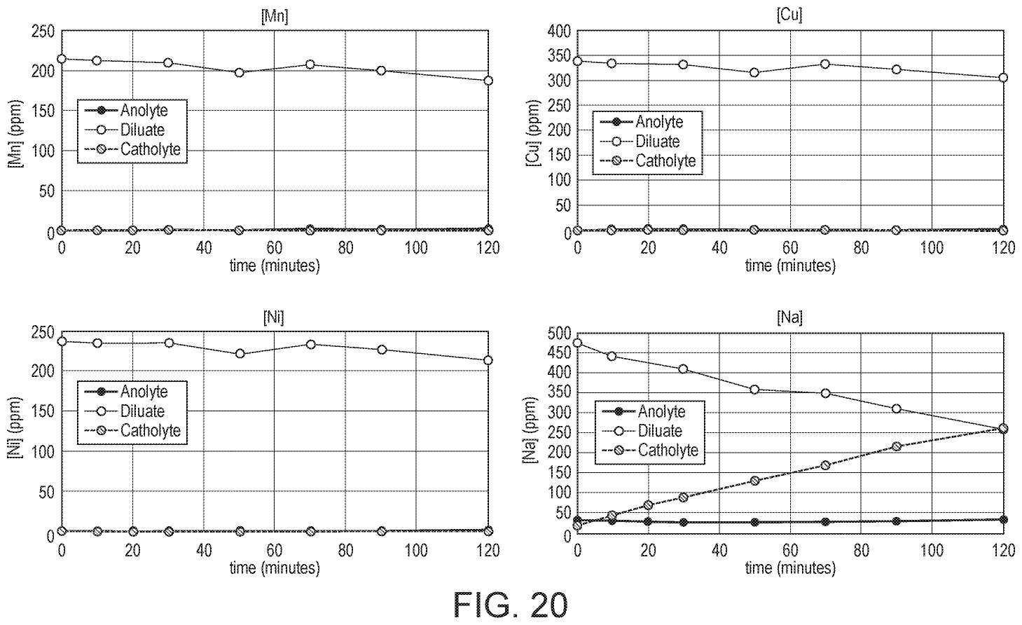

FIG. 20 shows concentrations of selected elements in the anolyte, diluate and catholyte. As was the case in the sulfate system, none of the multivalent metals crossed the membrane in significant quantities, while sodium crossed easily. In the sulfate system, the only multivalent elements to cross the membrane were copper and zinc. In the formate system, when normalised by initial concentration in the diluate, 2.2±0.1 Li⁺ ions cross the membrane for every Na⁺ ion and 5000±1500 Li⁺ ions cross for every Mn²⁺ ion. In the sulfate system there was no selectivity between sodium and lithium. However, there is a slight preference for lithium in the formate system. The different selectivities are likely to be caused by differences in metal solubility and local pH in the membrane.

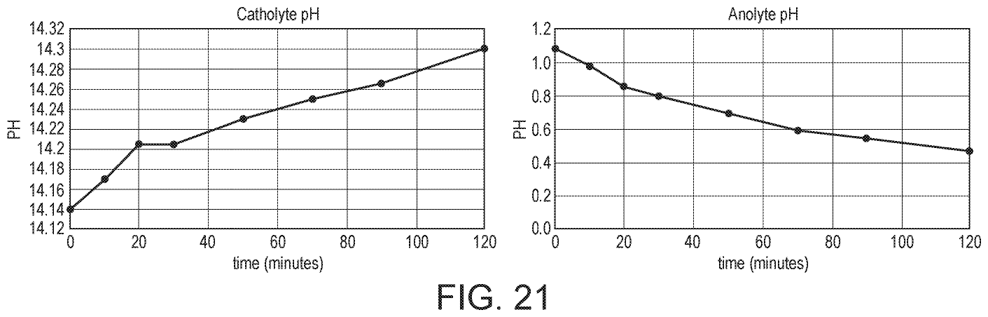

FIG. 21 shows catholyte and anolyte pH versus time. As can be seen from FIG. 21, the anolyte pH significantly decreases. This is because the Li⁺ ions lost to the diluate are replaced by protons produced at the anode. Interestingly, the pH of the catholyte increases in this experiment. This suggests that the rate of formic acid crossover was significantly lower. This is best explained by the lower initial formic acid concentration of 39% compared to 50%. The pH of the diluate remained constant in this experiment because the flow of lithium from the anolyte was reversed. By maintaining a higher pH throughout the experiment, the percentage of the formic acid present as an associated neutral molecule was lower, which would further reduce crossover.

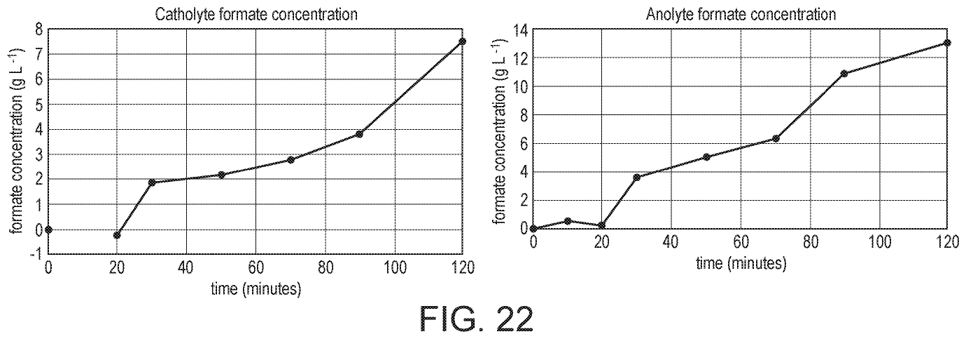

FIG. 22 shows the concentration of formate in the anolyte and catholyte over the electrolysis as determined by analysing the carbon concentration by ICP. Approximate standards were produced by dissolving sodium formate in sulfuric acid. Residual carbon in the blank standards, probably due to dissolved CO₂ from the air, meant the calibration curve was nonlinear and did not cross the origin, and furthermore, there was a high error in the ICP's replicate measurements. Therefore, the concentrations in FIG. 22 are not quantitative and are only included here to illustrate the trend. It is clear that the formate concentration in both the anolyte and catholyte increases over time, confirming that formic acid is crossing both membranes. Ion chromatography can be used to confirm and quantify the presence of formate in the anolyte and catholyte. The consequences are that any formic acid crossing to the anolyte will be oxidised to CO₂ at the anode and so will be lost, while the formic acid crossing to the catholyte will contribute to a mixture of lithium formate and lithium hydroxide.

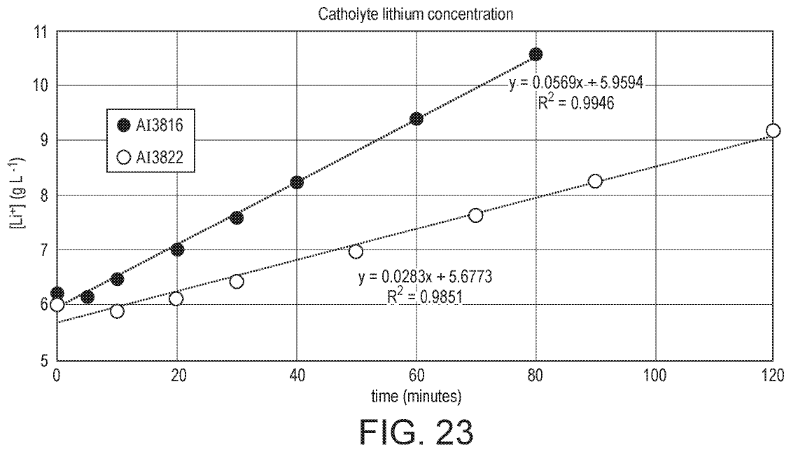

FIG. 23 shows a comparison of the changes in catholyte lithium concentration between two experiments (AI3816 and AI3822). Comparing the two experiments in FIG. 23, lithium concentrates much more rapidly in the catholyte in AI3816 in which the starting lithium concentration in the diluate is higher, providing a favourable concentration gradient. This translates to a large difference in current efficiency which is 67% for AI3816 and 40% for AI3822.

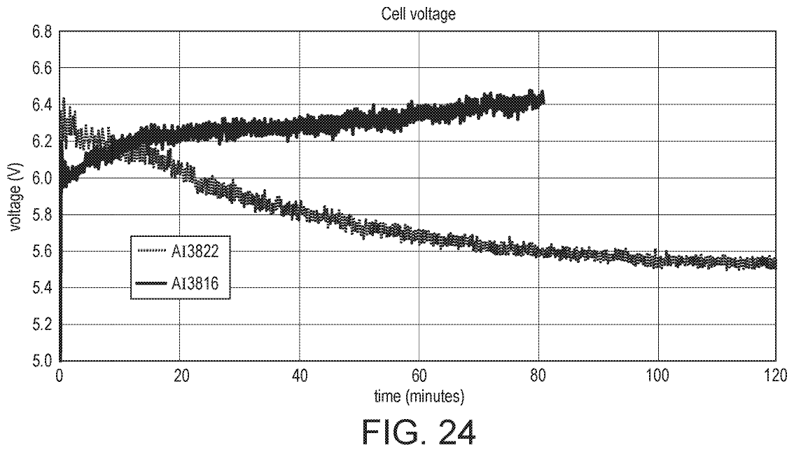

FIG. 24 shows a comparison of the cell voltages of AI3816 and AI3822. FIG. 24 shows the cell voltage to decrease in AI3822 and slightly increase in AI3816. This is most likely because the sulfuric acid concentration in the anolyte stayed relatively constant in AI3816 but increased in AI3822, thereby increasing the conductivity of the anolyte. Taking the cell voltage and current efficiency into account, the specific energy consumption to produce a kilogram of lithium hydroxide was 10.4 kWh kg⁻¹ for AI3816 and 16.1 kWh kg⁻¹ for AI3822. This is in the same range as the specific energy consumptions for a sulfate system.

In light of the above, it has been shown that it is possible to electrolyse lithium formate to lithium hydroxide and formic acid using a three-chamber approach. The Nafion 115 cation exchange membrane shows excellent selectivity for lithium over all metals apart from sodium. However, there is some crossover of formic acid to the anolyte and catholyte and this should be minimized by selecting membranes which minimize such crossover and/or by using a modified approach as described in the next section.

Using a “Neutralisation Chamber” to Eliminate Formic Acid Crossover in the Production of LiOH from Lithium Formate

In this approach, formic acid crossover from the diluate into the catholyte of an electrochemical cell is reduced by forcing the formic acid to travel through a high pH solution, causing it to dissociate and therefore reduce penetration through the cation exchange membrane in contact with the concentrate. A pure LiOH solution can be produced with significantly reduced contamination of formate ions and furthermore there is no need for there to be any significant loss of Li or formate.

In the electrolysis of a formic acid leach liquor of lithium ion battery black mass primarily containing lithium formate and between 30 to 70% v/v formic acid in water, there is a problem of loss of formic acid into the LiOH product of the electrolysis because it diffuses to some extent across the cation exchange membrane separating the LiOH from the leach liquor. It is able to diffuse across the membrane because it is mainly present as a neutral molecule below pH 3.75. When formate is present as an anion it is much more difficult for it to cross the membrane because it is electrostatically repelled by the negatively charged functional groups (e.g. sulfonate functional groups) of the cation exchange polymer.

When the formic acid leach liquor is directly adjacent to the LiOH, separated only by a cation exchange membrane, there is a pH gradient cross the membrane. This means that the pH is below 3.75 for much of the formic acid's path through the membrane and so it can diffuse easily until it reaches the higher pH region.

The method of this section almost entirely eliminates formic acid crossover by placing a “neutralisation chamber” between a leach liquor chamber and an LiOH product chamber in an electrochemical cell. The electrolyte in the neutralisation chamber is a mixture of lithium formate and lithium hydroxide which has its pH maintained above pH 5 at all times. Formic acid will cross over a first membrane from the leach liquor chamber into the neutralisation solution/chamber, but will then dissociate in the high pH solution, making it very difficult to cross a second membrane into the LiOH product chamber. Li⁺ ions cross the first cation exchange membrane into the neutralisation chamber and then cross a second cation exchange membrane into the LiOH catholyte. A small bleed of the LiOH produced in the catholyte is fed into the neutralisation solution at a rate sufficient to neutralise incoming formic acid by the following reaction:

LiOH+HCO₂H--≥LiCO₂H+H₂O.

A small bleed of the neutralisation solution is fed into the diluate with the leach liquor so that no lithium or formate is lost overall.

The overall cell configuration consists of an anode chamber with electrolyte separated from the diluate by a cation exchange membrane. The anolyte can be LiOH, formic acid, or another suitable electrolyte. The diluate contains the lithium formate/formic acid leach liquor and is separated from the neutralisation solution by a cation exchange membrane. The neutralisation solution is a mixture of lithium formate and lithium hydroxide and is separated from the catholyte by a cation exchange membrane. The catholyte is lithium hydroxide.

Accordingly, the purpose here is to force the formic acid to travel through a high pH solution to get to the LiOH product. Above pH 5, almost 100% of the acid is dissociated, making it much harder to cross a cation exchange membrane. As long as the neutralisation solution is maintained above pH 5, formic acid crossover into the LiOH product should be minimal. The neutralisation solution recirculates with a small bleed of the LiOH product fed in. As formic acid crosses the membrane it is neutralised by LiOH to become LiCO₂H. So that lithium and formate aren't lost, a small bleed of the neutralisation solution is fed into the leach liquor.

The hypothesis that the higher the pH of a central neutralization chamber the less the crossover has been proven. Crossover can be reduced by 99.7% compared to a cell configuration without such a neutralization chamber. In addition, selection of suitable membranes also enables a reduction in cross-over.

Experiments have been performed to measure the flux of formic acid across Nafion 115 and Nafion 424 cation exchange membranes with the goal of reducing formic acid crossover in electrolysis. The effect of formic acid concentration on the crossover rate has also been investigated. Further still, a modified cell setup has been designed in which there is a central chamber inserted between the formic acid feed and LiOH product chambers. The pH of solution in the central chamber has been modified to test the hypothesis that the higher the pH of the central solution, the lower the formic acid crossover will be into the LiOH product solution due to dissociation of the weak acid making it less able to cross the cation exchange membrane.

As described previously, in electrolysis, when formic acid crosses into the LiOH the result is a mixture of lithium formate and lithium hydroxide, but the desired product is LiOH. When it crosses into the anolyte it is likely to become lost due to oxidation at the anode. Furthermore, the more formic acid lost from the leach liquor the less can be recycled.

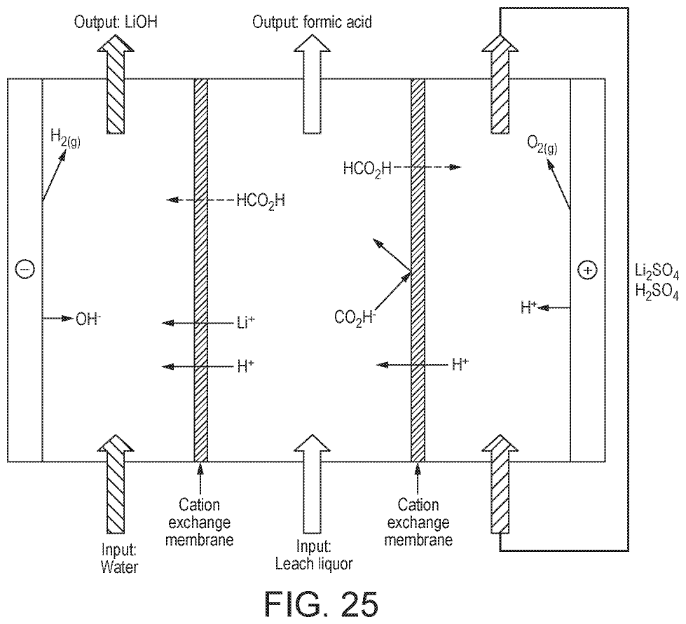

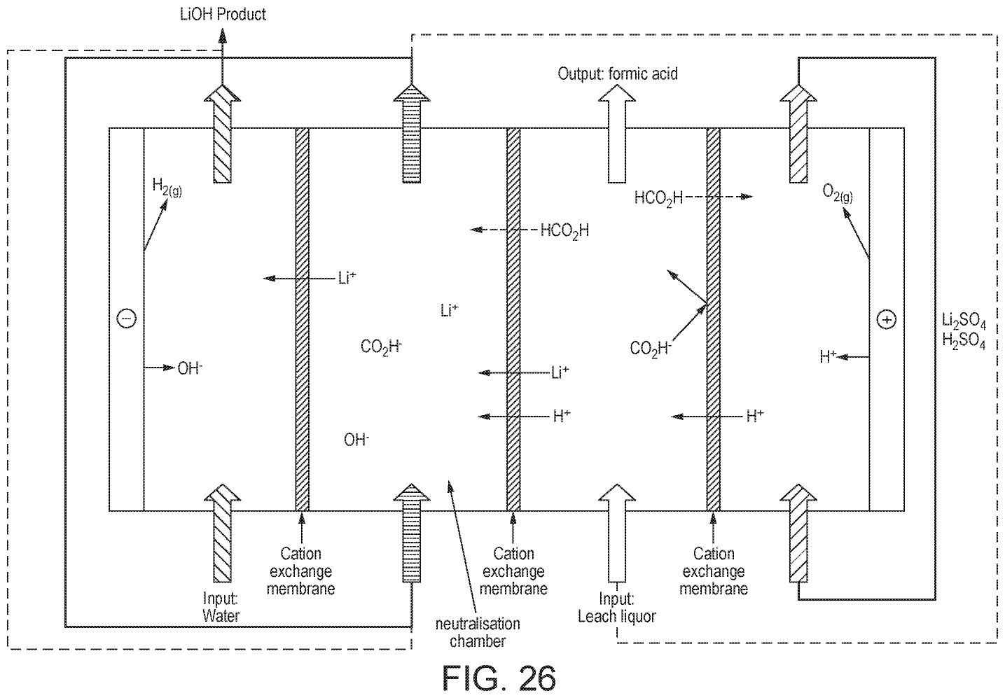

In the cell configuration shown in FIG. 25 (which is similar to that described in the preceding section), the formic acid feed chamber is directly adjacent to the LiOH product chamber. In contrast, in the cell configuration shown in FIG. 26 the formic acid feed chamber is separated by a “neutralisation chamber” from the LiOH product chamber. Experiments have been performed to test and compare the performance of the cell configurations shown in FIGS. 25 and 26 and different membranes for use in such configurations.

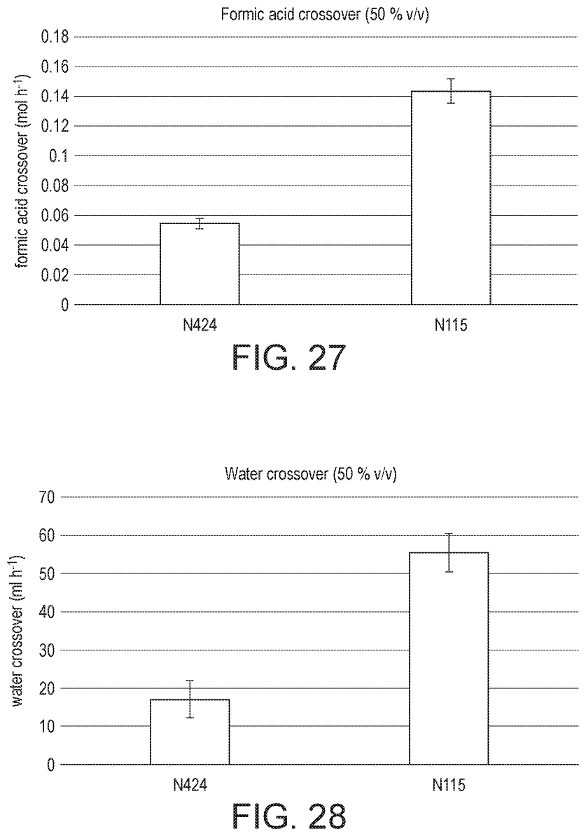

First, two different membranes, Nafion 115 and Nafion 424, were tested for formic acid and water cross-over using a formic acid concentration of 50%. By switching from a Nafion 115 membrane (127 micrometres thick) to a Nafion 424 membrane (380 micrometres thick) the formic acid crossover was reduced by 62% and the water crossover was reduced by 69% (see FIGS. 27 and 28). Reducing water crossover into the formic acid is also important because it causes dilution of the formic acid. Since it is desired to reuse the formic acid output from the electrolysis in the leach, it is undesirable for the formic acid to be diluted in the electrolysis process.

Although the Nafion 424 membrane is a thicker membrane, it permits a higher current efficiency by reducing back-diffusion of Li⁺. Therefore, there is no trade-off in terms of electrochemical performance by using this thicker membrane to reduce crossover. Another advantage of Nafion 424 is that it is reinforced with a polymer fibre for greater mechanical strength, which should significantly increase its durability in long term operation.

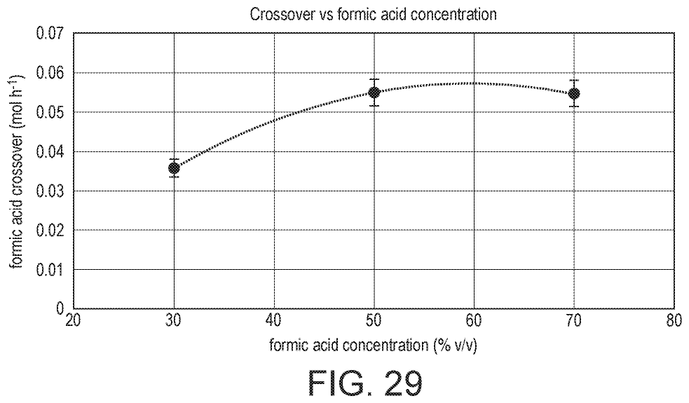

Using the Nafion 424 membrane, the effect of the formic acid concentration on crossover was investigated. As shown in FIG. 29, the crossover rate for formic acid increases, plateaus, and then declines as concentration is increased. The implications of this are that formic acid crossover can be significantly further reduced if the formic acid concentration of the leach is reduced to 30%. Another implication is that there is no penalty to increasing the formic acid concentration of the leach above 50%. This is advantageous because the selectivity of the leach for Li increases with formic acid concentration.

While selecting a membrane that reduces formic acid crossover is important, it doesn't fully eliminate crossover into the LiOH, which is what is desired. As such, the modified cell configuration of FIG. 26 was designed to reduce or eliminate any remaining formic acid crossover. In this regard, formic acid will travel through a cation exchange membrane much more easily when it is present in solution as an associated neutral molecule than if it is dissociated and present as an anion and cation. The pKa of formic acid is 3.75 and is almost entirely dissociated above pH 5. Therefore, by forcing the formic acid to travel through an intermediate solution with a pH greater than 5 before reaching the LiOH, crossover can be reduced to negligible levels. There is also the added benefit that comes from the fact that it has to diffuse across two, rather than only one, membrane to reach the LiOH.

In light of the above, the modified methodology is to operate a 4-chamber, rather than 3 chamber, cell in which the Li travels across a “neutralisation chamber” between the leach liquor and LiOH. Formic acid crossing from the leach liquor is neutralised by a small bleed of the LiOH product which is fed into the neutralisation chamber, forming lithium formate. A bleed of this lithium formate is then be fed into the diluate with the leach liquor so that no lithium or formate ions are wasted. As long as the pH of the neutralisation chamber solution is maintained above 5, this approach is effective.

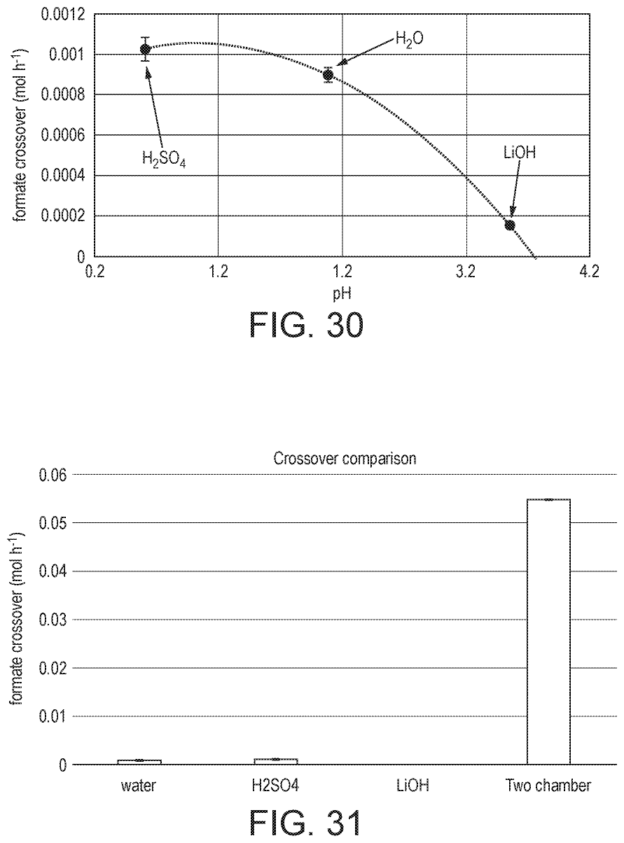

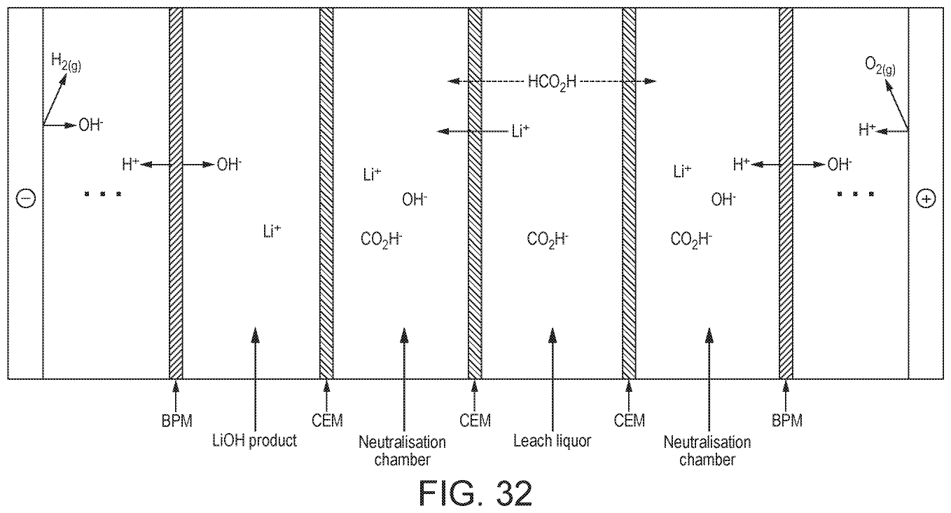

Three central chamber solutions were used in the 4-chamber cell configuration, water, 0.3 mol/L LiOH and 0.3 mol/L H₂SO₄. The final pH of each solution plotted against the rate of formic acid crossover into the water is shown in FIG. 30. It confirms the hypothesis that crossover rate decreases with increasing pH. The crossover rate was reduced by 82.6% when LiOH was used in the central chamber rather than water. The crossover rate would have been even lower if the LiOH had been replenished. The final pH of 3.5 suggests that all the LiOH was neutralised. In steady state operation the LiOH would be replenished.

As shown in FIG. 31, crossover was essentially eliminated using the 4-chamber configuration. Using an additional central chamber with LiOH reduced the crossover by 99.7% compared to a two-chamber experiment (both using Nafion 424 as the membrane).

In conclusion, this section has shown that Nafion 424 significantly reduces water and formic acid crossover compared to Nafion 115. Furthermore, the hypothesis that high pH reduces crossover was proved and crossover was reduced to negligible (unmeasurable by titration) levels by using a LiOH intermediate solution.

### SUMMARY

The present specification provides a number of methodologies for implementing a process for recycling Li from an input material comprising Li and one or more transition metals, comprising the steps of: contacting the input material with a leaching medium comprising an organic acid (e.g. formic acid); leaching Li from the input material to form a leachate comprising lithium (e.g. lithium formate); and electrolytically converting the lithium (e.g. lithium formate) to lithium hydroxide. In the context of battery materials recycling from so-called “black-mass” as an example, the process flow of FIGS. 3(a) and 3(b) has been achieved and can be implemented in a battery materials recycling flow sheet such as that illustrated in FIG. 2 in order to remove lithium from the black-mass prior to processing of the black-mass to extract, purify, and recycle other valuable metals including cobalt and nickel. A number of different electrochemical cell configurations have been described for the electrochemical conversion of lithium formate to lithium hydroxide including: (i) a cell configuration based on a repeating two-chamber configuration; (ii) a three-chamber configuration; and (iii) a four-chamber configuration including a central neutralisation chamber. Each of these configurations has been tailored to provide a high purity LiOH product while also enabling efficient recycling of formic acid. This is required for the lithium extraction approach to be economically and ecologically viable as a recycling method. The methodology can also be applied for processing of lithium from other input materials which comprise Li and one or more transition metals.

The electrochemical processing technologies are described in the context of using formic acid, and particularly concentrated formic acid, as the organic acid for leaching lithium from the input material. In this regard, the use of concentrated formic acid has been found to be advantageous in terms of selectively leaching lithium from an input material which comprises lithium and transition metals. That said, the same electrochemical processing technologies can be applied when using different organic acids for the leaching step. Examples of organic acids which can be used to leach lithium from the input material include formic acid, acetic acid, propionic acid, malonic acid, citric acid, butyric acid, oxalic acid, tartaric acid, or a mixture of several organic acids.

As such, while this invention has been particularly shown and described with reference to certain examples, it will be understood to those skilled in the art that various changes in form and detail may be made without departing from the scope of the invention as defined by the appended claims.

### REFERENCES

1. JP2012126583
2. JP2014173144
3. CN108689827A
4. JPWO2013153692A 1
5. “Formic acid regeneration by electromembrane processes”, Journal of Membrane Science 280 (2006) 509-516.
6. “Electro-membrane processes for organic acid recovery”, RSC Adv., 2019, 9, 7854.
7. “Application of electrodialysis to the production of organic acids”, Journal of Membrane Science, 288 (2007) 1-12.
8. “Three-compartment bipolar membrane electrodialysis for splitting of sodium formate into formic acid and sodium hydroxide”, Journal of Membrane Science 325 (2008) 528-536.
9. “Three compartment bipolar membrane electrodialysis of sodium formate”, Journal of Membrane Science, 2008, 325, pp. 528-536.
10. “Electrodialysis in water-ethanol solutions”, Desalination 154 (2003) 9-15.
11. “Transport of formic acid through anion exchange membranes”, Separation Science and Technology, 39:1, 165-184, 2005.
12. Gao et al., Environ. Sci. Technol., 2017, 51, 1662-1669.
13. CN110233302A
14. WO2018192121
15. CN105244564B
16. CN110563044A
17. CN111621643A

1. A method for recycling lithium from an input material comprising lithium and one or more transition metals, comprising the steps of:
contacting said input material with a leaching medium comprising an organic acid;
leaching lithium from the input material to form a leachate comprising an organic lithium salt; and
electrolytically converting the organic lithium salt into an inorganic lithium salt in an electrochemical cell.

2. A method according to claim 1, wherein the inorganic lithium salt is lithium hydroxide or lithium carbonate.

3. A method according to claim 1 or 2,
wherein the organic acid in the leaching medium is formic acid,
wherein the leachate comprises lithium formate, and
wherein the lithium formate is converted to the inorganic lithium salt in the electrochemical cell.

4. A method according to any preceding claim,
wherein the electrochemical cell comprises one or more membranes which are selective to the transmission of monovalent lithium over multivalent transition metals such that the electrochemical cell functions to both convert the organic lithium salt into the inorganic lithium salt and also separate the lithium from multivalent transition metal impurities in the leachate.

5. A method according to any preceding claim,
further comprising a multivalent metal separation step applied to the leachate to remove multivalent transition metal impurities prior to electrolysis of the leachate.

6. A method according to any preceding claim,
further comprising recycling the organic acid from the electrochemical cell for re-use in the contacting and leaching steps.

7. A method according to claim 6,
where at least 50%, 60%, 70%, 80%, or 90% by weight of the organic acid in the leaching medium is recycled from the electrochemical cell.

8. A method according to any preceding claim,
further comprising selectively precipitating the inorganic lithium salt produced in the electrochemical cell at a temperature of at least 60° C., 70° C., 80° C., 90° C., or 100° C.

9. A method according to claim 8,
wherein supernatant from the precipitation is recycled to the electrochemical cell.

10. A method according to claim 8 or claim 9,
further comprising washing the precipitated inorganic lithium salt and recycling wash liquor to the electrochemical cell.

11. A method according to any preceding claim,
wherein the electrochemical cell comprises a diluate chamber for receiving the leachate and a concentrate chamber separated from the diluate chamber by a cation exchange membrane which selectively allows lithium ions to pass from the diluate chamber to the concentrate chamber forming the inorganic lithium salt in the concentrate chamber while blocking multivalent transition metals.

12. A method according to claim 11,
wherein multivalent transition metals are periodically removed from the cation exchange membrane by chemically stripping or by periodically reversing the cell current.

13. A method according to claim 11 or 12,
wherein the electrochemical cell comprises an anolyte chamber in contact with an anode, the anolyte chamber being separated from the diluate chamber adjacent the anolyte chamber by a bipolar membrane, and
wherein the electrochemical cell comprises a catholyte chamber in contact with a cathode, the catholyte chamber being separated from the concentrate chamber adjacent the catholyte chamber by a bipolar membrane.

14. A method according to any one of claims 11 to 13,
wherein the electrochemical cell comprises more than one pair of diluate and concentrate chambers.

15. A method according to claim 14,
wherein the electrochemical cell comprises at least 3, 4, 6, 8, 10, 15, 20, 50, 100, 200, 300, or 350 pairs of diluate and concentrate chambers.

16. A method according to claim 11 or 12,
wherein the electrochemical cell comprises an anolyte chamber in contact with an anode, the anolyte chamber being separated from the diluate chamber adjacent the anolyte chamber by a cation exchange membrane.

17. A method according to any one of claims 11 to 16,
wherein the electrochemical cell further comprises a neutralization chamber disposed between the diluate chamber and the concentrate chamber, and
wherein the neutralization chamber is maintained at a pH above 4, 5, or 6.

18. A method according to any one of claims 11 to 16,
wherein the electrochemical cell further comprises a neutralization chamber disposed between the diluate chamber and the concentrate chamber, and
wherein the neutralization chamber is maintained at a pH above a pKa of the organic acid.

19. A method according to any preceding claim, wherein the input material comprises one or more of nickel, manganese, and cobalt, in addition to lithium.

20. A method according to any preceding claim, wherein the input material is a lithium battery scrap material.
